(19) United States
(12) Patent Application Publication
(10) Pub. No.: US 2006/0190462 A1
(43) Pub. Date: Aug. 24, 2006

(54) Global satellite databases and security systems

(76) Inventor: Amit Bhri, Yonkers, NY (US)

Correspondence Address: AMIT BHRI, 14 RIBBON LANE, WANTAGH, NY, 11793, US

(21) Appl. No.: 11/196,062

(22) Filed: Aug. 3, 2005

Related U.S. Application Data
(60) Provisional application No. 60/654,698, filed on Feb. 18, 2005.

(51) Int. Cl. G06F 7/00

(52) U.S. Cl. 707/100

(57) ABSTRACT

The objective of the current invention is to provide an advanced and effective means of security checks performed for airline travelers and other administrative functions as well. It makes use of satellites to host databases containing personal information about the citizens of the member countries. Anybody who needs to travel at any given point of time is identified at the time of check-in at the airport by comparing the information contained in the airline's database and information retrieved from the satellite. The retrieval of information is based on the unique piece of information; thumb impression. All the information in the satellite is saved corresponding to the thumb impression and is integrated from the national databases like social security department database, motor vehicle department database, Passport Authority database etc. The thumb impression scan will be required of the passenger at the airport. All the information corresponding to the thumb impression will be downloaded and compared against the airline's database. If the information is matched the passenger is issued a boarding pass. This will eliminate the scope for duplication of identity will keep a tab on the passengers flying with multiple identities. Also the different administrative units of any country will be able to use these satellite databases with integrated information about every individual in the country for their daily activities. The customer will have to provide the thumb impression in the administrative unit and the appropriate information related to the customer will be retrieved from the satellite. The desired action will be taken by the administrative unit to process the customer request and the additions or changes made to the customer information will be updated in the integrated satellite database. The implementation of Global Satellite Databases and Security Systems will help countries manage their administrative databases in one place and implement the airline security measures using the same system.

### REFERENCES

| PATENT NO. | NAME | PATENT DATE | CLASS |
|---|---|---|---|
| 5,081,703 | Lee | Jan. 14, 1992 | 455/13.1 |
| 5,225,842 | Brown, et al | Jul. 6, 1993 | 342/357.09 |
| 5,448,623 | Wiedeman, et al | Sep. 5, 1995 | 455/430 |
| 5,969,669 | Ishikawa, et al | Oct. 19, 1999 | 342/357.02 |
| 6,243,648 | Kilfeather, et al | Jun. 5, 2001 | 701/213 |

### BACKGROUND OF THE INVENTION

The satellite systems today provide information about weather, our solar system, other information related to space exploration, global positioning and numerous other purposes. As of now, the satellites have not been used to host and provide information for routine activities of every country in the world. In today's world, almost all the countries are using computer systems for all their administrative tasks like social security, motor vehicle registration, passport authority and various other authorities. All these departments perform their functions independently of others. Any citizen of a country has to deal with almost all the departments. All these departments work as per their rules and regulations and carry information about the citizen depending on their own requirements. It is quite possible that the information with one department may not be present with the other department. Also these departments have their offices in almost every city of respective countries. As such it is very difficult to integrate and maintain data from all the locations of all the departments.

In the case of Airline travel, the Passport Authorities provide unique the passport number as the unique identification criterion for the person. With the current standards, passengers can have multiple passports with different details because they are not based on any unique identification means associated with the person. But if the unique identification criterion coming from the person like the thumb impression is used in all the places and all the documents for a person are based on the thumb impression, it is possible to reduce the instances of multiple identifications Thus there is a need for a system to have all the information about a person based on a unique identification measure. It will also be highly desirable to have all the information about a person in one place and there should be means to access information about a person using this unique identification measure. Again it is also difficult to integrate current information from different places.

The current invention solves all these problems. The objective of the current invention is to integrate all the information for all the citizens for a country on a satellite and all the information is based on the unique identification parameter thumb impression. All the departments from that country can access this information. Also all the data is in one place. So all the departments in all the locations can access this data or modify this data based on the identification provided by the person.

### SUMMARY OF THE INVENTION

The global satellite databases and security systems provide a means of global database management and security systems for airline travelers and other authorities related to any country in the world. This system is based on the fact that:
1) all the information related to a person's identification is integrated in a common satellite database system
2) There is at least one unique physical identifier for a person (in this case a thumb impression) which is also connected to the person's information in a database.

The unique identifier should be used for all confidential purposes or security related purposes. For example, the thumb impression of a person should be linked to their social security, driver's license, passport number etc.

The major emphasis is on having these databases stored on to the satellites. All major administrative institutions should be able to contact these satellites and download or modify the information based on their requirements. One such system is Airline reservation and security system.

When the customers purchase their tickets, they are supposed to provide their passport number and other essential contact information. Once the ticket is reserved and the person is ready for his/her scheduled journey and reach the airport, they just have to provide their thumb impression on the terminal provided by the airport authorities. Once the thumb impression is scanned, a match is searched for in the satellite system. When the match is found, the following credentials are downloaded:
1. First Name
2. Middle Initial if any
3. Last Name
4. Passport Number
5. Country of Citizenship
6. Date of Birth
7. Country of Passport Issuance
8. Date Passport Issued
9. Passport Expiration Date
10. Place of Birth
11. Photograph
12. Address

Now the information obtained from the satellite is compared with the information in the airline database. Once the information is matched, the boarding-pass and other travel related information is printed for the customer. As this information is processed for the customer, a copy is sent out to each stop-over and the destination of the flight. This provides complete tracking arrangements and the end-points can contact the appropriate agencies in case they find something not in tune with their systems.

The Global Satellite Database and Security Systems provides a method of maintaining global databases and security protocols hosted on a group of satellites which are accessed from the clients on the ground. These satellites host two types of database systems; namely Global Thumb Impression Database and Continental Satellite Database System which form the Global Satellite Database and Security Systems. The Global thumb impression database acts as a directory or control database and the Continental satellite database system hosts the actual database. There is only one Global thumb impression database but there are multiple Continental Satellite Database Systems. These databases are accessed from the devices installed on earth which act as clients to request the information.

The Global Satellite Databases and Security Systems require approximately the following information for a person:
a. First Name
b. Middle Name (if any)
c. Last Name
d. Thumb Impression
e. Social Security Number
f. Driver's License Number
g. Date of Birth
h. Place of Birth
i. Passport Number
j. Date Passport Issues
k. Passport Expiration Date
l. Photograph (updated from time to time)

The integration of above data from different national systems' databases makes Continental Satellite Database System. It is a database containing above mentioned information and residing on a satellite and requires highly classified access to the data. Continental Satellite Database System can be used in a variety of administrative purposes including airline travel; both national and international. An arrangement should be made for all continents to deploy Continental Satellite Database System satellites containing database for countries in that continents having entries for all the people if possible and at least for the people having passports in a particular country.

The Global thumb impression database containing names, thumb impressions, country of citizenship, passports numbers related to the thumb impressions should be maintained and acts like an index to search a person's detail that is scheduled to fly. This database is also contained in a satellite which acts as a guiding satellite to direct passport number obtained from Global Thumb Impression Database to the appropriate Continental Satellite Database System.

The Continental Satellite Database System and Global Thumb Impression Database combines together to form Global Satellite Databases and Security Systems. The complete Global Satellite Databases and Security Systems will work as follows:

The Continental Satellite Database System satellites contain data for the people of whole world but based on continents and countries in a particular continent. There is at least one satellite corresponding to each continent. All the countries have their individual databases on this satellite. The satellites for each continent have different names and so does the database name for each country. For example the satellite for Asia will be called CSDS.ASIA_SOUTH and the database for India will be called DB.CSDS_ASIA_SOUTH.INDIA. This database will have citizens' details under the guidelines for Global Satellite Databases and Security Systems. Now as an individual decides to travel and purchase a ticket from a particular airline or an agent authorized by the airline, he or she will have to provide the following information to obtain the ticket:
a. First Name
b. Middle Name, if any
c. Last Name
d. Date of Birth
e. Passport Number
f. Identification Number

As the ticket is booked the traveler details are transmitted to the Airline database along with the journey details.

On the day of journey, as the customers reach the ticket counter of the airline, they are asked to provide the thumb impression scan on the terminal. The terminal in the airport contacts the Global Thumb Impression Database and search the match for thumb impression. When the match is found in Global Thumb Impression Database, the other information namely Nationality and Passport Number are returned. Based on the nationality, the Global Thumb Impression Database directs the control to the Continental Satellite Database System of the particular country's database in that continent's satellite. The Passport number obtained from Global Thumb Impression Database is searched in the Continental Satellite Database System country database. When the matching entry in the database is found, complete information about a person is transmitted to the terminal in the airport on the screen and matched with the passenger information in the airline database. This is pretty secure method as the data in the satellites is integrated from various administrative institutions and is authentic. When the information is matched, the boarding-pass is issued for the customer along with the itinerary details. At the same time, a copy is sent out to the stop-over and the destination.

The same procedure is applied to international travelers. As Global Thumb Impression Database exists, when the customer provides the thumb impression, the passport number and country of citizenship are revealed by the Global Thumb Impression Database and the satellite corresponding to the country of citizenship is contacted. The passport number is searched in the country database and the required information is downloaded to the computer. This information is compared with the airline database and thus the verification process is completed. The boarding-pass is issued to the customer and the copy is also sent to the stop-over and the destination.

In the case of international flights however, the last step is extended. There may be certain cases where additional searching has to be done about a traveler. It may be possible that the traveler is allowed to fly from the source but is prohibited from traveling to the destination country. In such a case, when the information becomes available to the destination just at the time when the boarding-pass is being issued, the destination country's security agency can research more on the travelers and can verify their identities from their intelligence databases which may maintain a list of travelers with other-than-ordinary credentials. Thus security measures can be taken in a very little time. The same is the case with the stop-over countries. They can also verify the information by checking the details received against their security databases.

One of the major advantages of venturing into Global Satellite Databases and Security Systems is that there will be no duplication of identities. It is a known fact that the thumb impression for each and every person in this world is unique. If a Global Thumb Impression Database is maintained containing a catalog of all the thumb impressions in the world or at least for the people having passports, the duplicate identities for a person can be avoided. In today's scenario, a person can use the same photograph but can use different names and other credentials. Going by the current system, even if a Global Database is maintained but without thumb impression, a person can have multiple identities and thus can have aliases. But if thumb impression is made a necessary feature for identification and all information is saved and retrieved by means of thumb impression, there will be no duplication, provided the fact that these thumb impressions are constantly compared with other thumb impressions in the database to provide a security measure against any duplication. Since the thumb impression will be a unique parameter in this system, there cannot be two set of personal details with one thumb impression.

Apart from this, the population of each country can be documented provided the condition that all the countries take measures to provide some sort of identification to its citizens and documents all the people with or without passports. This will keep track of the population of the world.

With advanced security measures, this data can be accessed by different institutions such as financial institutions, universities, health department, and social security benefits and so on. With the satellites built with huge capabilities, they will be able to handle multiple transactions at the same time.

### BRIEF DESCRIPTION OF THE DRAWINGS

FIG. 1 shows the compete Global Satellite Databases and Security Systems diagram

FIG. 2 shows the Ground Terminal Unit Node System diagram

FIG. 3 shows the Global Thumb Impression Database System Diagram

FIG. 4 shows the Continental Satellite Database System Diagram

FIG. 5 shows the Information Request by the Ground Terminal Unit

FIG. 6 shows the Information Processing by the Global Thumb Impression Database System

FIG. 7 shows the Information Processing by the Continental Satellite Database System

FIG. 8 shows the Information Processing by the Node

FIG. 9 shows the Information Processing by the Ground Terminal Unit

FIG. 10 shows the Global Thumb Impression Transaction Database

FIG. 11 shows the Continental Satellite Transaction Database

FIG. 12 shows the Node Transaction Database while contacting Global Thumb Impression Database System

FIG. 13 shows the Node Transaction Database when Continental Satellite Database System contacts the Node

FIG. 14 shows the Administrative Terminal Unit Node System Diagram

FIG. 15 shows the Administrative Unit Communication System Diagram

FIG. 16 shows the Request by the Administrative Terminal Unit

FIG. 17 shows Step 1 of Processing by the Administrative Unit Communication System

FIG. 18 shows Step 2 of Processing by the Administrative Unit Communication System

### DETAILED DESCRIPTION OF THE INVENTION

The Global Satellite Databases and Security Systems provides a method of maintaining global databases and security protocols hosted on a group of satellites which are accessed from the clients on the ground. These satellites host two types of database systems; namely Global Thumb Impression Database System and Continental Satellite Database System which form the Global Satellite Database and Security Systems. The Global Thumb Impression Database System acts as a directory or control database and the Continental satellite database system hosts the actual information database. There is only one Global Thumb Impression Database System but there are multiple Continental Satellite Database Systems. These databases are accessed from the devices installed on earth which act as clients to request the information.

The Global satellite databases and security systems are based on the fact that:
1) all the information related to a person's identification is integrated in a common satellite database system
2) There is at least one unique physical identifier for a person (in this case a thumb impression) which is also connected to the person's information in a database.

The unique identifier should be used for all confidential purposes or security related purposes. For example, the thumb impression of a person should be linked to their social security, driver's license, passport number etc.

The major emphasis is on having these databases stored on to the satellites. All major administrative institutions should be able to contact these satellites and download or update information as per their requirements. One such system is Airline security system.

Components to make the Global Satellite Databases and Security Systems Work

a. Ground Terminal Unit Node System
b. Global Thumb Impression Database System
c. Continental Satellite Database System

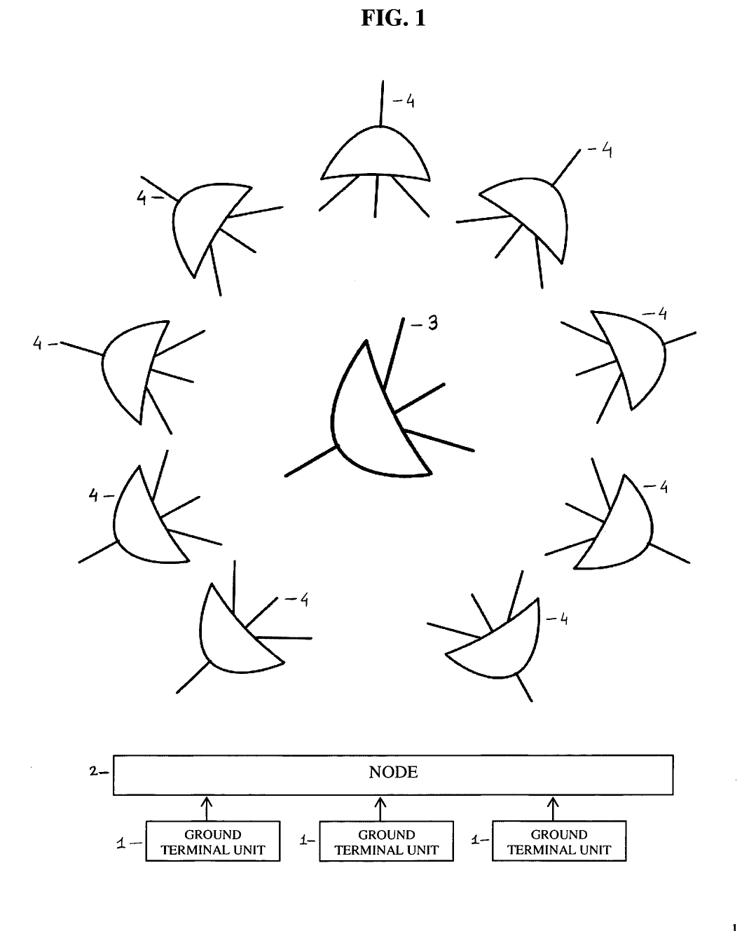

FIG. 1 shows the components that make the Global Satellite Databases and Security Systems work. 1 is the Ground Terminal Unit which initiates the request. 2 represents the Node consisting of multiple Ground Terminal Units. 3 shows the Global Thumb Impression Database System and 4 shows the Continental Satellite Database System. The Ground Terminal Unit initiates the information request hosted on the Continental Satellite Database System. The Ground Terminal Unit transmits the thumb impression of a person to the Global thumb impression database satellite through the Node. The Global Thumb Impression Database system finds the Passport number and the country of citizenship related to the thumb impression in the Global Thumb Impression Database and forwards it to the Continental Satellite Database System which contains complete information about the person The passport number is searched in the Continental Satellite Database System and when found returns the information about the person. But before this information is sent back to Node the thumb impression from Continental Satellite Database System is compared with the thumb impression received from Node. This provides an indirect yet complex and efficient means of identity verification. The Continental Satellite Database System returns the information to the Ground Terminal Unit that initiated the request. The functions performed by these three components are as follows:

Ground Terminal Unit Node System

The Ground Terminal Unit initiates the request for information. It sends the thumb impression of the passenger to the Global Thumb Impression Database System. The Ground Terminal Unit in the current invention is referred to the airport terminal computer which starts the request. There can be multiple Ground Terminal Units initiating a request with the Global Thumb Impression Database System. All the ground terminal units throughout the world have unique addresses. The Ground Terminal Unit that initiates a request for connection with Global Thumb Impression Database system uses this unique address to identify itself. The facility that holds ground terminal units is called a Node. Like each Ground Terminal Unit, each Node has a unique identification. To send the request originated by the Ground Terminal Unit, the Node contacts the Global Thumb Impression Database System with its identification and sends the thumb impression and the Ground Terminal Unit address to the Global Thumb Impression Database system. Once the information has been transmitted to the Global Thumb Impression Database system, the connection is closed as the information corresponding to the thumb impression is returned by the Continental Satellite Database System. For the information request initiated with the Global Thumb Impression Database system, the Node and thus the Ground Terminal Unit is contacted by the Continental Satellite Database System with the information. A Ground Terminal Unit cannot initiate a new request before its previous request has been resolved.

Global Thumb Impression Database Sysyem

Global Thumb Impression Database System is hosted on one satellite and acts as the index and security monitor for the complete System. The Global Thumb Impression Database System has the following sub-components:
a. Node Location Directory: Node Location Directory contains a list of all the Nodes in the world. This enables Global Thumb Impression Database ascertain the authenticity of the client.
b. Terminal Location Directory: Terminal Location directory contains a list of all the Ground Terminal Units in the world.
c. Country-Satellite Directory: Country-Satellite Directory contains a list of all the countries and the Continental Satellite Database System where a particular country's database is located.
d. Global Thumb Impression Database: This database contains the thumb impressions, passport numbers and country of citizenship for all the passengers. As the thumb impressions for two people can never match, this database enables security check against passengers who can otherwise fly with different names and passport numbers. Using this there would not be one person with one thumb impression and two passport numbers.

The Global thumb impression database system receives the thumb impression from the Node and returns the passport number and country of citizenship for the passenger. It then contacts the Continental Satellite Database System and sends the information over to Continental Satellite Database System. The Global Thumb Impression Database also sends the address of the Node and Ground Terminal Unit to be contacted.

Continental Satellite Database System

The Continental Satellite Database System maintains the databases for the member countries in a continent. All the countries in a continent have their database systems on this satellite. The current invention will deploy a total of nine Continental Satellite Database System satellites. The Continental Satellite Database System contains compete information about a person in a given country. The Continental Satellite Database System has the following sub-components:
a. Country Database: Each country allocated to one Continental Satellite Database System has a database maintaining all the information for all its citizens.
b. CountryList: The CountryList contains a list of all the countries in a Continental Satellite Database System and is accessed in order to forward or direct the information to the appropriate country.

The Continental Satellite Database System receives the thumb impression, passport number, country of citizenship, address of Node and the address of Ground Terminal Unit from the Global Thumb Impression Database System. Based on country of citizenship of the passenger, the database for the country is contacted and the passport number is searched for in the database. When the passport number is found, the thumb impression from the Continental Satellite Database Systems' country database is compared with the thumb impression sent by Global Thumb Impression Database. If matched, the Continental Satellite Database System contacts the Ground Terminal Unit at the address specified by Global Thumb Impression Database System and transmits the information to Ground Terminal Unit.

Naming Conventions Used for Components

The components of the current invention will follow naming conventions and their addresses will also be standardized as they will be part of information transmission process. The naming and address conventions for these components will be as follows:

Ground Terminal Unit Node System

As there could be millions of Ground Terminal Unit initiating requests at the same time, there is standardized procedure for ascertaining the location of a particular Ground Terminal Unit. The address for a given Ground Terminal Unit is as follows:

TerminalID.TerminalNodeID.TerminalCityID.TerminalCountryID

This address has the following parts:

a. TerminalID

b. TerminalNodeID

c. TerminalCityID

d. TerminalCountryID

The TerminalID is the name of the computer in the facility. The facility is known as a node and has a unique address as is identified by TerminalNodeID. The TerminalCityID is the city the terminal node is in. The TerminalCountryID is the country the terminal is in. In this manner, the complete address for a terminal is always unique. These addresses are registered with the Global Thumb Impression Database in its Terminal Location Directory.

The Nodes are also distinguished by the same address procedure and the node address is assigned as follows:

CNodeID.NodeCityID.NodeCountryID

This address has the following parts:

a) CNodeID

b) NodeCityID

c) NodeCountryID

The CNodeID is the name of the node hosting the Ground Terminal Unit. The NodeCityID is the city the node is in. The NodeCountryID is the country the node is in. All the node addresses of the world are registered with the Global Thumb Impression Database in the Node Directory.

Global Thumb Impression Database System

As Global Thumb Impression Database System is a single satellite and is the forwarder of a request, there is no specific address formulation for Global Thumb Impression Database. The Global Thumb Impression Database System will be assigned a unique identity. This unique identity will be used by the Global Thumb Impression Database System to identify itself with the Continental Satellite Database System before transmitting the information.

The unique identity provided to the Global Thumb Impression will be used in combination with other identification measures to form a complete address with which it will contact the Continental Satellite Database System. These identification measures are:
a. Distance of the Global Thumb Impression Database System from Earth.
b. Distance between Global Thumb Impression Database System and each Continental Satellite Database System.

The above mentioned information will be available with the Continental Satellite Database System also. The Unique identity will be appended with these specifications and the resulting data will be encrypted by means of encryption software. The encrypted identity of the Global Thumb Impression Database System will be known as GTIDENC. The Global Thumb Impression Database System will contact the Continental Satellite Database System with GTIDENC and the Continental Satellite Database System will decrypt the data and verify the identity of the contacting Global Thumb Impression Database System. Each Continental Satellite Database System will contain the same information

For added security, the unique identity of the Global Thumb Impression Database System will be changed frequently and will be updated in the each Continental Satellite Database System as well. This will result in different encrypted patterns for the Thumb Impression Database System identity.

The Terminal Location directory in the Global Thumb Impression Database System contains a list of addresses of all the Ground Terminal Units in the world. The Terminal Location Directory will follow the same naming means as the Ground Terminal Unit. This is how the location of a Ground Terminal Unit will be identified. The Node Location Directory contains a list of all the nodes in the world and follows the same naming systems as the Nodes. All the Nodes and the Ground Terminal Unit locations are registered with the Global Thumb Impression Database System.

Continental Satellite Database System

The Continental Satellite Database System is a group of nine satellites containing databases for countries in that particular continent. The names of the satellites will be as follows:

a) CSDS_AUS (For Australia)

b) CSDS_ASIA_EAST (For East-Asian countries)

c) CSDS_ASIA_SOUTH (For South-Asian countries)

d) CSDS_ASIA_MIDEAST (For Middle-Eastern countries)

e) CSDS_AFR (For African Countries and Antarctica)

f) CSDS_EUR (for European countries excluding Russia)

g) CSDS_RUS

h) CSDS_NA (For North American countries, Greenland and Caribbean countries)

i) CSDS_SA (For South American countries)

These satellites will have databases for the member countries. These databases will have the following naming procedure:

DB.CSDS_CONTINENT.COUNTRY

This address has the following parts:

a) DB

b) CSDS_CONTINENT

c) COUNTRY

DB is prefix for Database. CSDS_CONTINENT is the name of the continent. COUNTRY is the country whose database is being contacted. For instance the database for India will be addressed as DB.CSDS_ASIA_SOUTH.INDIA

The general naming convention for a Transporter Layer is as follows:

TP.CSDS_CONTINENT.COUNTRY

Structure of the Systems

In the current invention, the information must be transmitted by means of security protocols. As there is considerable amount of information transfer takes place between the components of the system and since this transfer should be considerably secure, the components of the system are made up of multiple layers to identify the source of each request, to provide secure access to the database and to transmit the resulting data to the originator of request by means of security protocols.

Structure of Gorund Terminal Unit Node System

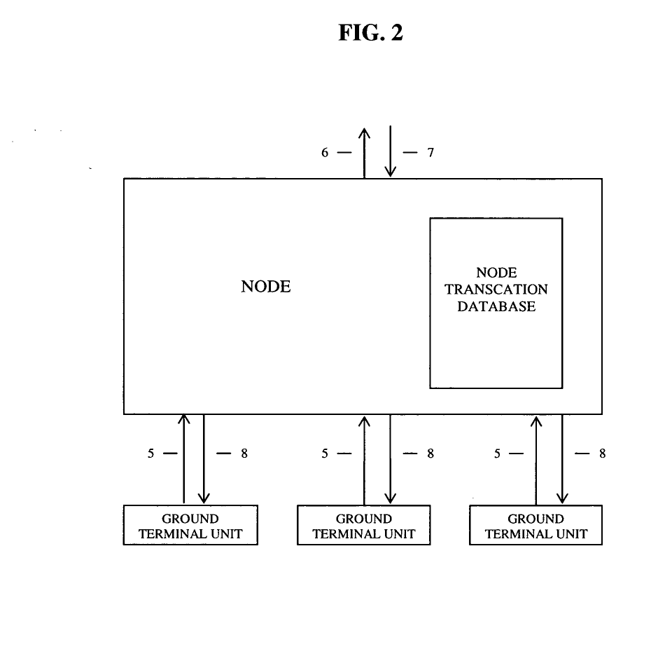

The Node is a collection of Ground Terminal Units in a given facility. All the Ground Terminal Units have unique addresses and originate the request for information. This request is forwarded by the Node. Thus, a given Node consists of several Ground Terminal Units and Node Transaction Database to keep track of the transaction status initiated by each Ground Terminal Unit. FIG. 2 describes the structure of the Node with Ground Terminal Units in it. The request for information placed by the Ground Terminal Unit is shown by 5. The information forwarded by the Node to the Global Thumb Impression Database System is shown by 6. For the request placed by the Ground Terminal Unit, the Node is contacted by the Continental Satellite Database System with the results. This is shown by 7. The Node receives the information and forwards it to the Ground Terminal Unit that initiated the request as shown by 8.

Structure of Global Thumb Impression Database System

The Global Thumb Impression Database System is hosted on a Global Thumb Impression Database satellite. The Global Thumb Impression Database consists of the following information:
a. Thumb Impressions and acts as the unique entity in the database
b. First Name of the person
c. Last name of the person
d. Passport Number
e. Country of Citizenship

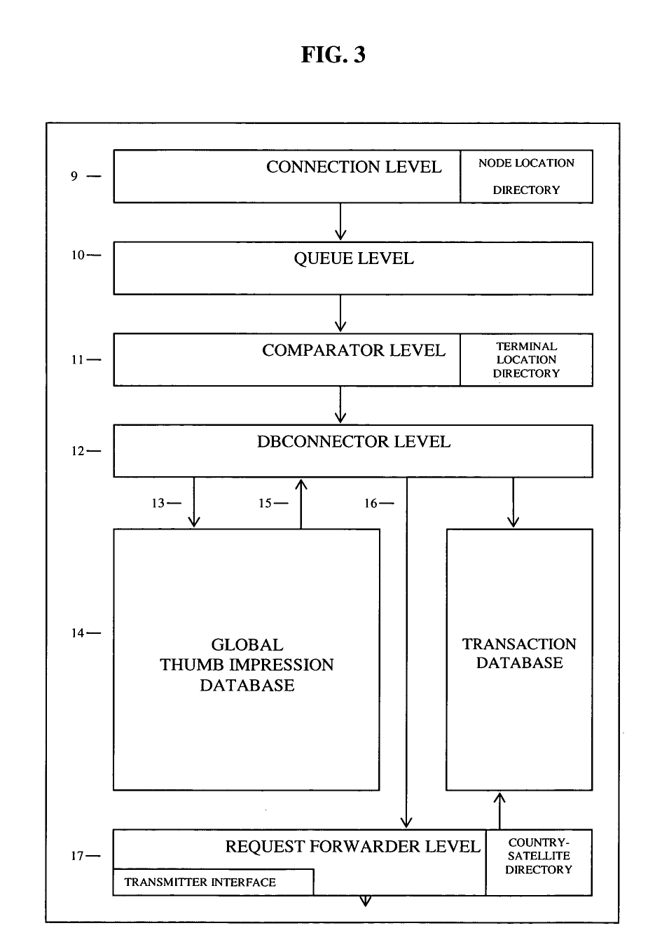

FIG. 3 describes the structure of the Global Thumb Impression Database System. As the Global Thumb Impression Database System communicates with Ground Terminal Unit and Continental Satellite Database System, its structure enables it to verify the identity of Ground Terminal Unit, receive data from the Ground Terminal Unit and then to send the data securely to appropriate Continental Satellite Database System. The Global Thumb Impression Database system has five levels, a Node Location Directory, a Terminal Location Directory, a Country-Satellite Directory, a Global Thumb Impression Database and a Global Thumb Impression Transaction Database. The five levels are:
1. Connection Level
2. Queue Level
3. Comparator Level
4. DbConnector Level
5. Request Forwarder Level

The request for access to the Global Thumb Impression Database is generated by the ground terminal unit and the Node containing the Ground Terminal Unit contacts the Global Thumb Impression Database System. The access to database is granted only when the node and Ground Terminal Unit are identified by the Global Thumb Impression Database System.

The purpose of the Connection Level as shown by 9 is to respond to the connection request from the Node. But before it accepts the data from the Node, it identifies the node by checking it in the Node Location Directory. When the node is identified as listed with the Global Thumb Impression Database System, the information is passed on to the next layer. The Queue Level shown by 10 receives the data from the Connection Level. The data is entered into the Queue Level in the order it is received. The next level is Comparator Level as shown by 11 and receives data from the Queue Layer. The Comparator checks the address of the Ground Terminal Unit in the Terminal Location Directory. After checking the status of the Ground Terminal Unit, the data is transferred to the DbConnector Level shown by 12. The DbConnector Level receives the information from the Comparator Level and search for thumb impression in the Global Thumb Impression Database as shown by 14. 13 shows the request placed by the DbConnection Level. It gets the results from the database as shown by 15 and appends it to the data received from the Comparator Level and sends the resulting information to the Request Forwarder Level. 16 shows the communication between the DbConnector Level and the Request Forwarder Level. The DbConnector Level also has access to the Global Thumb Impression Transaction Database which is maintained to record all the transactions handled by the Global Thumb Impression Database System. The function of Request Forwarder Level is to get the data from the DbConnector Level and send it to the appropriate Continental Satellite Database System. Upon receiving the data from the DbConnector Level the Request Forwarder Level checks the country of citizenship for the passenger and checks the Country-Satellite Directory and ascertains the Continental Satellite Database System to be contacted. The Request Forwarder Layer has a Transmitter Interface which is used to send connection request to the Continental Satellite Database System. The function of the Transmitter Interface is to combine the unique identity of the Global Thumb Impression Database System, the distance between Global Thumb Impression Database System and Earth, and the distance between the Global Thumb Impression Database System and the Continental Satellite Database System to be contacted and encrypt the combined data to form encrypted identity GTIDENC, the encrypted identity of the Global Thumb Impression Database. This identity of the Global Thumb Impression Database System is verifies by the Continental Satellite Database System when contacted.

Structure of Continental Satellite Database System

The Continental Satellite Database System contains the integrated data for the member countries in the continent with each country having its own database. For example, CSDS_AUS contains the data for citizens of Australia. The following data regarding a citizen is needed in the Continental Satellite Database System database:
1. First Name
2. Middle Initial if any
3. Last Name
4. Passport Number
5. Country of Citizenship
6. Date of Birth
7. Country of Passport Issuance
8. Date Passport Issued
9. Passport Expiration Date
10. Place of Birth
11. Photograph
12. Address
   Additional information can be added to the country database, if necessary.

The database for each country in the Continental Satellite Database System is a collection of all the national databases. The Continental Satellite Database System can be integrated from these databases. These national databases contain all the information about an individual based on their own requirements and may not be coherent with other national databases. One of the biggest advantages of the Continental Satellite Database System databases can be that all the government departments throughout the nation can use the Continental Satellite Database System database for their day-to-day routine activities. Thus all the information related to a person can be integrated into one database hosted on a satellite.

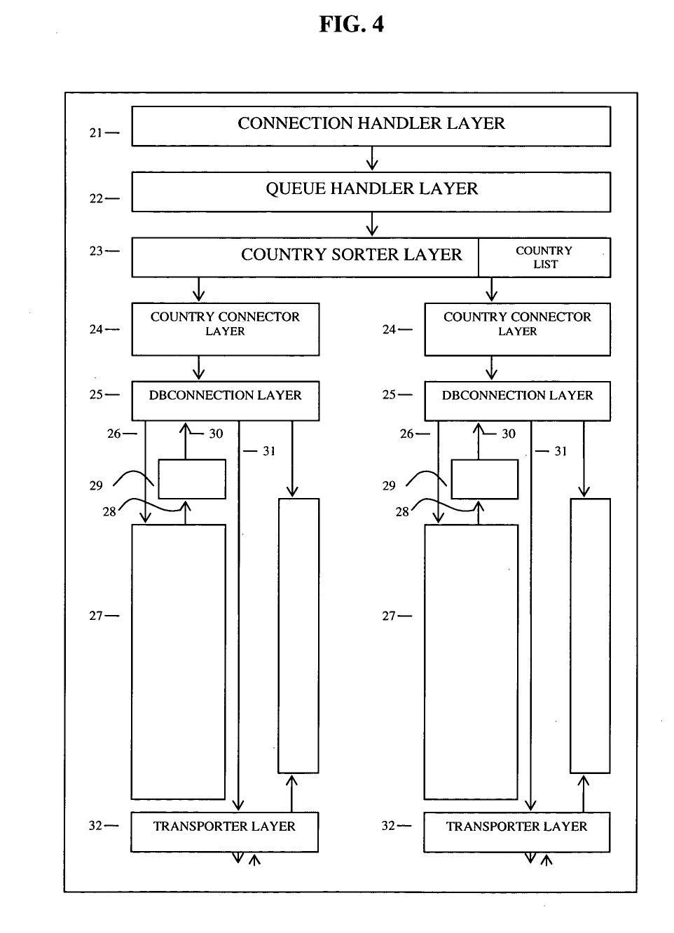

FIG. 4 shows the structure of the Continental Satellite Database System. The Continental Satellite Database System is made up of seven layers, CountryList, Country Database for each country in the system and Continental Satellite Transaction Database for each country. The seven layers of the Continental Satellite Database System are:
1. Connection Handler Layer
2. Queue Handler Layer
3. Country Sorter Layer
4. Country Connector Layer
5. DbConnection Layer
6. Validator Layer
7. Transporter Layer

The Connection Handler Layer shown by 21 accepts connections from the Transmitter Interface of the Request Forwarder Level of Global Thumb Impression Database System. The function of Connection Handler Layer is to communicate with the Global Thumb Impression Database, decrypt the encrypted identity GTIDENC to verify the identity of the contacting Request Forwarder Level of the Global Thumb Impression Database System, receive the data and send an acknowledgment for the data received. The Connection Handler Layer can handle multiple connections at any given time. The Connection handler Layer then forwards the data received to Queue Handler Layer as shown by 22. The purpose of the Queue Handler Layer is to receive data from the Connection Handler Layer and add it to the queue in the order in which the data is received. The Queue Handler Layer in a given Continental Satellite Database System contains data for all the member countries in that particular Continental Satellite Database System. The Queue Handler Layer is also capable of handling multiple transactions at the same time. But there is only one centralized queue in which the data is entered. Thus the Queue Handler Layer contains query data from different Ground Terminal Units or nodes around the world.

The purpose of Country Sorter Layer shown by 23 is to sort the data received from the Queue Handler Layer and forward it to appropriate Country Connector Layer. Thus the Country Sorter Layer is an interface between the Queue Handler Layer and the Country Connector Layer. The Country Sorter Layer sorts the data based on country to which the data should be forwarded to.

The Country Sorter Layer objects find the country of citizenship from the information received from Queue Handler Layer and searches for it in the CountryList. The CountryList contains the list of all the countries in the Continental Satellite Database System and the address of the Country Connector Layers corresponding to all the countries in the list. The Country Sorter Layer then contacts the appropriate Country Connector Layer and forwards the information to it.

The Country Connector Layer as shown by 24 is the place where all the queries are corresponding to a particular country. There are Country Connector Layers for all the countries in a given Continental Satellite Database System. Beyond this point, all the countries have their own layers. For security purposes any Country Connector Layer cannot connect with other Country Connector Layers. The Country Sorter Layer acts as an overlap for all the layers below it.

The DbConnection Layer shown by 25 for a particular country receives data from the Country Connector Layer. This layer establishes connection with the country database shown by 27 and check the data received from the Country Connector Layer. 26 shows the connection between the DbConnection Level and country database. The Dbconnection Layer also can handle multiple connections at any given time. The DbConnection Layer also establishes connection with the Transaction Database to keep track of all the transactions a country is handling.

29 shows the Validator Layer for a country and performs the double check before the information from the country database is sent to the Ground Terminal Unit. 28 shows the data received by the Validator Layer from the Country Database and compares the thumb impression transmitted by the Global Thumb Impression Database System with the thumb impression retrieved from the country database. The Validator Layer works in conjunction with the Dbconnection Layer. If the match is found, it notifies the Dbconnection Layer of the result as a positive match as shown by 30. The Dbconnection Layer then forwards the data to the Transporter Layer shown by 32. 31 shows the data being transmitted by the DbConnection Layer to the Transporter Layer. The data forwarded to the Transporter layer is the resulting set of information from the country database and the data received by Dbconnection layer from the Country Connector Layer. The Transporter Layer communicates with the Node based on the information received from the Dbconnection Layer. Once the authenticity check is performed, the data can be transferred to the Node by the Transporter Layer. The Transporter Layer also accesses the Continental Satellite Database System transaction database to modify the transaction related to the information it handles. To implement the security measures the Transporter Layer cannot initiate connection with any other layer but can establish connection with the Transaction Database.

The Process

The complete process of receiving the information involves the components of the said system of the current invention to communicate with the clients and with each other. The process starts with the origin of request from the Ground Terminal Unit and ends with the transmission of data from Continental Satellite Database System to Ground Terminal Unit.

Information Request by Ground Terminal Unit

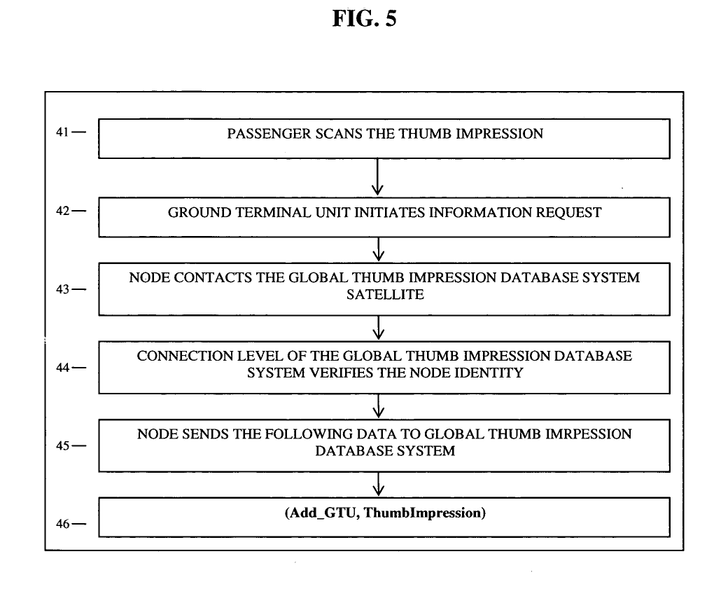

FIG. 5 shows the information request initiated by the Ground Terminal Unit. The Ground Terminal Unit sends the data directly input by the passenger as shown by 41. When the thumb impression is scanned to the Ground Terminal Unit shown by 42, the Ground Terminal Unit initiates a request with the Global Thumb Impression Database System in order to transmit the thumb impression. The request initiated by the Ground Terminal Unit is sent to the Global Thumb Impression Database System by the Node as shown by 43. The Node establishes contact with the Connection Level of Global Thumb Impression Database System described by 44 with its node address. The Node Address is defined as follows:

CNodeID.NodeCityID.NodeCountryID

The Node contacts the Global Thumb Impression Database System with the following data as shown by 45 and 46:

(Add_GTU, ThumbImpression)

where Add_GTU is the address of the Ground Terminal Unit denoted by TerminalID.TerminalNodeID.TerminalCityID.TerminalCountryID and ThumbImpression is the thumb impression scanned by the passenger at the terminal. The Connection Level checks the Node Address in the Node Location Directory.

Information Processing by Global Thumb Impression Database System

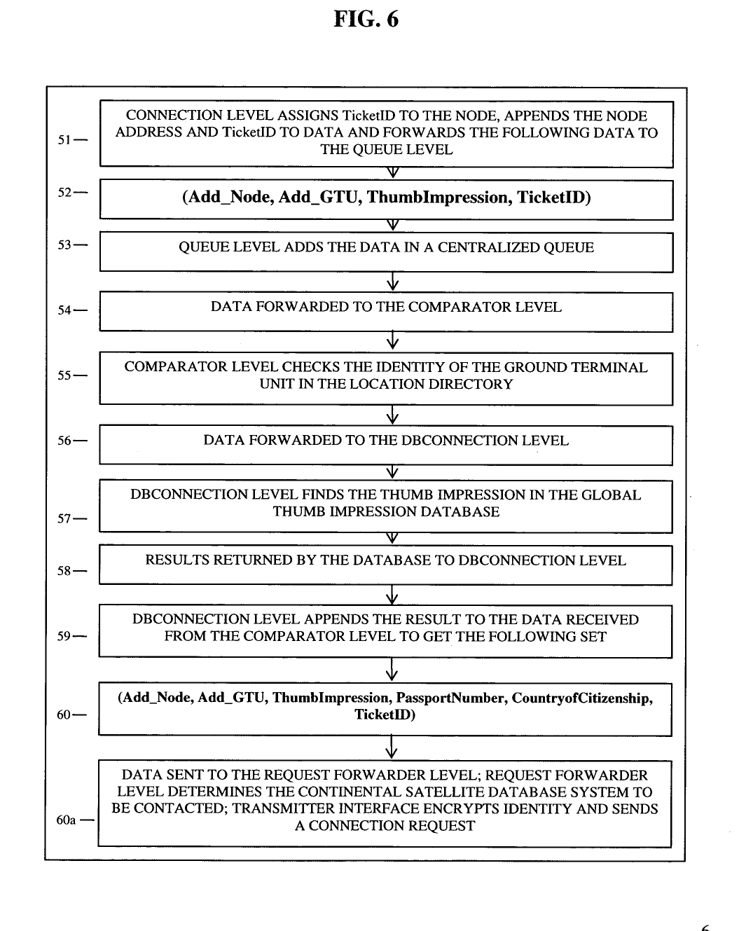

FIG. 6 describes the information processing by the Global Thumb Impression Database System. When the Node is identified as a trusted client, the Connection Level receives the data and assigns a unique TicketID to the Node as shown by 51. The Connection Level closes the connection with the Node and appends the Node address and TicketID to the data it has received and forwards the complete set to the Queue Level as follows:

(Add-Node, Add_GTU, ThumbImpression, TicketID) as shown by 52.

As shown by 53, the Queue Level of the Global Thumb Impression Database System receives this data set and enters it in the queue in the order in which it is received. 54 shows the data forwarded by the Queue Level to the Comparator Level. The Comparator Level checks the identity of the Ground Terminal Unit by its address. It checks the Add_GTU in the Terminal Location Directory as shown by 55. If the match is found, the Comparator Level forwards the complete data set to the DbConnector Level as shown by 56. The DbConnector Level initiates the connection with the Global Thumb Impression Database. Upon establishing the connection, the DbConnector checks the ThumbImpression in the database as shown by 57. If the ThumbImpression is found in the database, the contents of the database namely the PassportNumber and CountryofCitizenship are returned as shown by 58. The DbConnector Level attaches this data to the existing data set as shown by 59 and the resulting data set shown by 60 is as follows:

(Add_Node, Add_GTU, ThumbImpression, PassportNumber, CountryofCitizenship, TicketID)

The DbConnector Level object then closes the connection with the database. The resulting data set is forwarded to the Request Forwarder Level as shown by 60a. The Request Forwarder Level checks the CountryofCitizenship for the passenger in the Country-Satellite List. Based on this the Request Forwarder Level calculates the Continental Satellite Database System to be contacted which is CSDS.CONTINENT. At this point, the Transmitter Interface of the Request Forwarder Level creates the encrypted identity GTIDENC for the Global Thumb Impression Database System by combining the unique identity assigned to the Global Thumb Impression Database System, the distance between the Global Thumb Impression Database System and Earth, and the distance between the Global Thumb Impression Database System and the Continental Satellite Database System to be contacted.

Continental Satellite Database System Processing

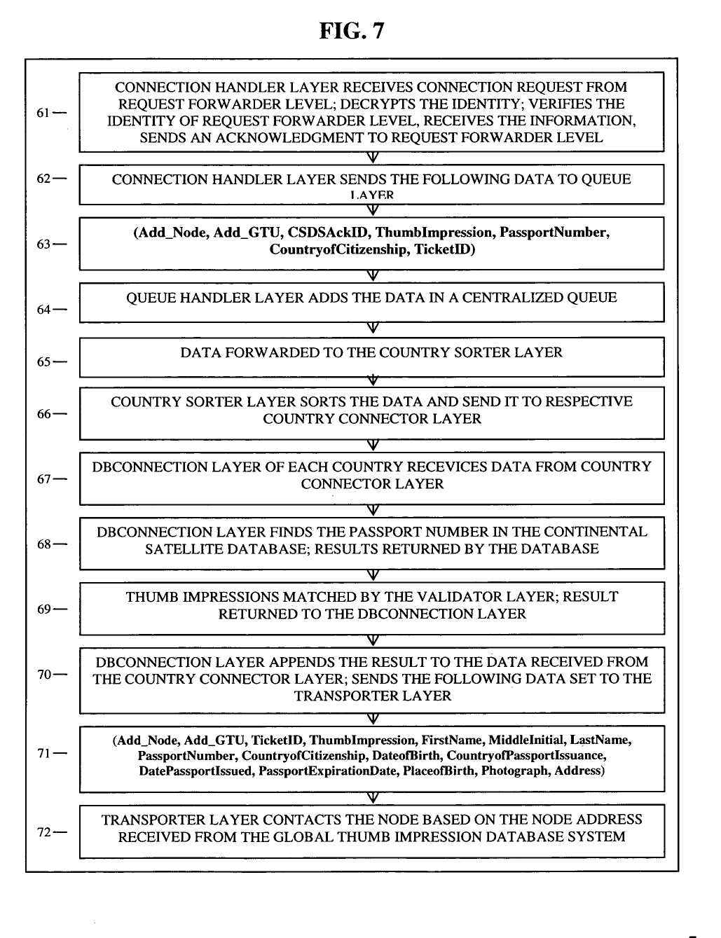

FIG. 7 describes the information processing by the Continental Satellite Database System. The Connection Handler Layer of the Continental Satellite Database System accepts connection from the Request Forwarder Layer of the Global Thumb Impression Database System as shown by 61. The Connection Handler Layer decrypts the encrypted identity GITDENC and verifies the unique identity, the distance between the Global Thumb Impression Database System, and the distance between the Global Thumb Impression Database System and itself. After the verification, the Global Thumb Impression Database System sends the following data to Connection Handler Layer:

(Add_Node, Add_GTU, ThumbImpression, PassportNumber, CountryofCitizenship, TicketID)

The Connection Handler Layer acknowledges the receipt of data and sends acknowledgment (CSDSAckID) to the Global Thumb Impression Database System. The Connection Handler Layer sends the acknowledgment only when the data is successfully received. The connection is then closed by Global Thumb Impression Database System and the connection is closed only when the Global Thumb Impression Database System has received an acknowledgment. When the connection is closed, the Connection Handler Layer forwards the data to the Queue Handler Layer as shown by 62. The Connection duration between the Global Thumb Impression Database and the Continental Satellite Database System is short because there are multiple requests originated by the Global Thumb Impression Database System and it's the single forwarder of the requests. The Connection Handler Layer appends the acknowledgment CSDSAckID to the data it has received from the Global Thumb Impression Database System and the complete data set is as follows:

(Add_Node, Add_GTU, CSDSAckID, ThumbImpression, PassportNumber, CountryofCitizenship, TicketID) as shown by 63.

The Queue Handler Layer is the one that receives the data from the Connection Handler Layer in the order in which it is received by the Connection Handler Layer. There are multiple Queue Handler Layer objects that receive data from the Connection Handler Layer. The purpose of these Queue Handler Layer objects is to enter the data into one centralized queue as shown by 64.

As is evident, these first two layers are the passages for data from Global Thumb Impression Database to the country databases of the Continental Satellite Database System. These layers do not have any connection with the database. The Queue Handler Layer contains data from different Ground Terminal Units around the world and for different countries in the same Continental satellite Database System. The Queue Handler Layer passes the data on to the Country Sorter Layer which is as follows:

(Add_Node, Add_GTU, CSDSAckID, ThumbImpression, PassportNumber, CountryofCitizenship, TicketID)

The Country Sorter Layer is where the data is sorted. The Country Sorter Layer receives the data from the Queue Handler Layer as shown by 65. The Country Sorter Layer receives the incoming data in the order they were entered in the Queue Handler Layer. The Country Sorter Layer reads the country of citizenship and checks it in the CountryList which specifies the location of Country Connector Layer for each country. Based on the output from the CountryList, the Country Sorter Layer contacts the Country Connector Layer to forward the data as shown by 66.

The Country Connector Layer has the interfaces equal to the number of countries in the Continental Satellite Database System. All the layers below the Country Sorter Layer are country-specific. For security purposes the Country Connector Layers cannot connect to each other and do not share any hardware resources with each other. These Country Connector Layers have a verification barrier before they accept the data from the Country Sorter Layer. When contacted by the Country Sorter Layer, the Country Connector Layer checks the country of citizenship parameter in the data set. Upon verification it receives the data from the Country Sorter Layer. The next step in this process is to initiate a connection with the database. The following data set is forwarded by the Country Connector Layer:

(Add_Node, Add_GTU, CSDSAckID, ThumbImpression, PassportNumber, CountryofCitizenship, TicketID)

As the data is sorted with the data for each country in their respective places, the Country Connector Layer forwards the data to the DbConnection Layer as shown by 67. Each Country Connector Layer in a Country Handler Layer has its own DbConnection Layer. As the country of citizenship is already verified, it is now not used in connection with the database. There are multiple connections that can be established with a country database at any given time. The DBConnection Layer initiates a connection request with the country database named DB.CSDS_CONTINENT.COUNTRY. After establishing connection with the country database, it checks the passport number in the database as described by 68. The passport number is a unique identity in the database because there cannot be two passports with the same number. When the passport number is found in the database, the database returns the following data to the DBConnection Layer:
1. Thumb Impression
2. First Name
3. Middle Initial if any
4. Last Name
5. Passport Number
6. Country of Citizenship
7. Date of Birth
8. Country of Passport Issuance
9. Date Passport Issued
10. Passport Expiration Date
11. Place of Birth
12. Photograph
13. Address

At this point the DBConnection Layer consists of two sets of data; one received from the Global Thumb Impression Database System and other received from the country database of the Continental Satellite Database System. Both these sets contain the thumb impression. One thumb impression is provided by the passenger at the Ground Terminal Unit and the second is the one saved in the country database of the Continental Satellite Database System. For added security these two thumb impressions are matched. If they match, the extended authentication process is completed and the data can be sent to the Node and thus the Ground Terminal Unit.

The DBConnection Layer works in conjunction with the Validator Layer. The Validator Layer compares the thumb impressions received from the DBConnection Layer as shown by 69. If the two thumb impressions match, the Validator Layer sends an acknowledgment to the DbConnection Layer. The DBConnection Layer combines both sets of data and the completed data set is forwarded to the Transporter Layer as shown by 70. The completed data set shown by 71 is as follows:

(Add_Node, Add_GTU, TicketID, ThumbImpression, First Name, Middle Initial, Last Name, Passport Number, Country of Citizenship, Date of Birth, Country of Passport Issuance, Date Passport Issued, Passport Expiration Date, Place of Birth, Photograph, Address)

This data can be sent to the Ground Terminal Unit described by the address received from the DBConnection Layer. The data is transferred to the Ground Terminal Unit by the Transporter Layer as shown by 72. Once the DBConnection Layer transfers the data to the Transporter Layer, it closes the connection to the database.

The DbConnection Layer does not send the CSDSAckID to the Transporter Layer. Instead, it enters the CSDSAckID in the Continental Satellite Transaction Database and discussed separately.

The Transporter Layer for each country sends data related to the country database only. The Transporter Layer is responsible for sending the data received from DbConnection Layer to the Ground Terminal Unit that initiated the request.

The Transporter Layer cannot establish connection with any other layer in the system. Also the Transporter Layer cannot establish connection with other Transporter Layers. But the Transporter Layer can establish contact with the Transaction Database of Continental Satellite Database System in order to record the successful transmission of data to the appropriate Node and thus the Ground Terminal Unit.

Node and Ground Terminal Unit Processing

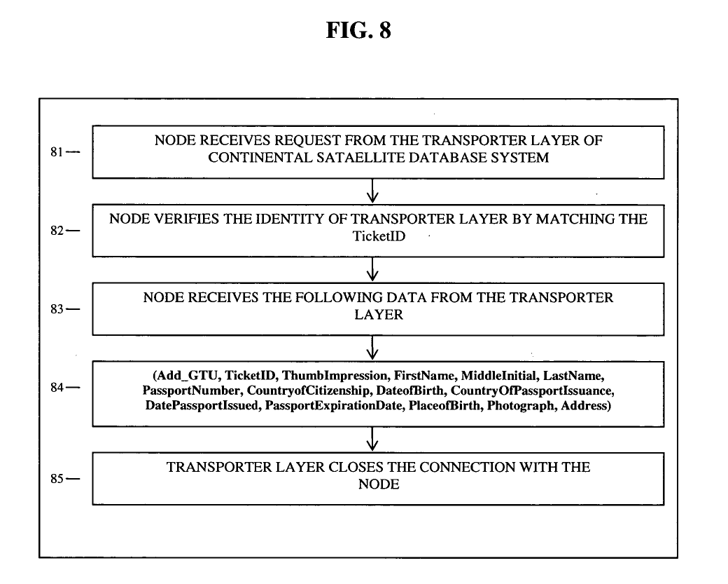

FIG. 8 shows the information processing done by the Node. Based on the Node address the Transporter Layer initiates a connection with the Node as shown by 81. The Node acknowledges the connection request and requests the TicketID that it received from the Global Thumb Impression Database System. The Transporter Layer sends the TicketID and the Node verifies it with its own TicketID issued by the Global Thumb Impression Database System as shown by 82. Once the TicketID is verified to be correct, the Transporter Layer sends the data requested by the Node. As shown by 83 and 84 the Node receives the following data from the Transporter Layer:

(Add_GTU, TicketID, ThumbImpression, First Name, Middle Initial, Last Name, Passport Number, Country of Citizenship, Date of Birth, Country of Passport Issuance, Date Passport Issued, Passport Expiration Date, Place of Birth, Photograph, Address)

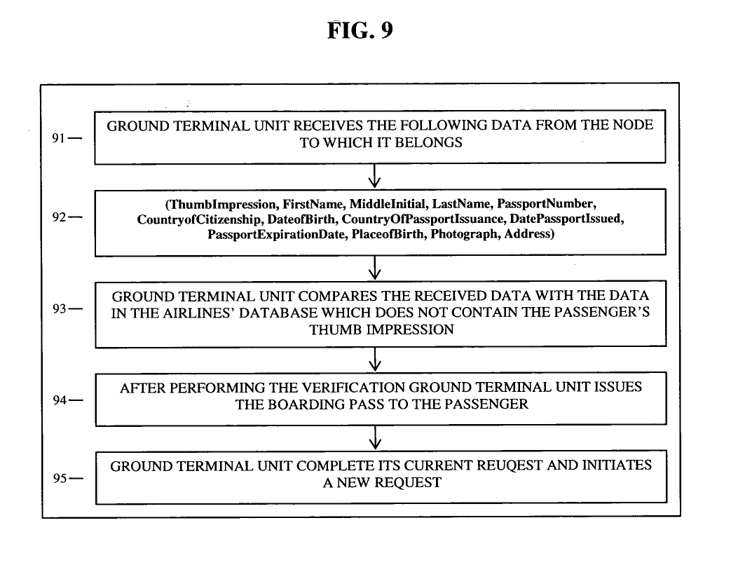

Once the data is received, the Node send an acknowledgment to the Transporter and the Transporter Layer closes the connection as described by 85. The Node in turn checks which Terminal Unit under it initiated the request and forwards the data to it. The Ground Terminal Unit, upon receiving the information from the node, performs its intended function. FIG. 9 shows the processing done by the Ground Terminal Unit. As shown by 91 and 92, the Ground Terminal receives the following data from the Node:

(First Name, Middle Initial, Last Name, Passport Number, Country of Citizenship, Date of Birth, Country of Passport Issuance, Date Passport Issued, Passport Expiration Date, Place of Birth, Photograph, Address)

The Ground Terminal Unit compares the information received from the Node with the passenger information in the airline database as described by 93. This information is provided by the passenger at the time of making a reservation and this information does not include the thumb impression. This allows the system to verify the identity of the passenger from his/her real attribute which is the thumb impression. Once the information is verifies, the boarding pass is issued for the customer as shown by 94. The complete system makes sure that the passenger is traveling with the right identity. With this the process is completed and the Ground Terminal Unit can initiate a new request as shown by 95.

Transaction Database

Each component of the system maintains a log of all the transactions they initiate or complete. This is done by maintaining a Transaction database by each of them. The following three transaction databases are maintained:
a. Global Thumb Impression Transaction Database
b. Continental Satellite Transaction Database
c. Node Transaction Database

These three transaction databases maintain records of transactions handled by Global Thumb Impression Database System, Continental Satellite Database System and the Node. These transaction databases do not record information related to any individual. Instead, the transaction databases save information which can verify the status of the request from Node to Global Thumb Impression Database System, from Global Thumb Impression database system to Continental Satellite Database System and from Continental Satellite Database System to the Node.

Global Thumb Impression Transaction Database

The Global Thumb Impression Database System maintains a Transaction Database in addition to the Global Thumb Impression Database. This database provides information about all the transactions between the Node and Global Thumb Impression Database System and between Global Thumb Impression Database System and Continental Satellite Database System. Any transaction being initiated with Global Thumb Impression Database or by Global Thumb Impression Database is recorded in the Transaction Database. In fact Global Thumb Impression Database System acts as a forwarder of request from Ground Terminal Unit to Continental Satellite Database System.

The Global Thumb Impression Transaction Database contains the following information:
a. GTIDTransNum
b. Add_Node
c. Add_Ground Terminal Unit
d. TicketID
e. DT_CSDS
f. Add_CSDS
g. CSDSAckID

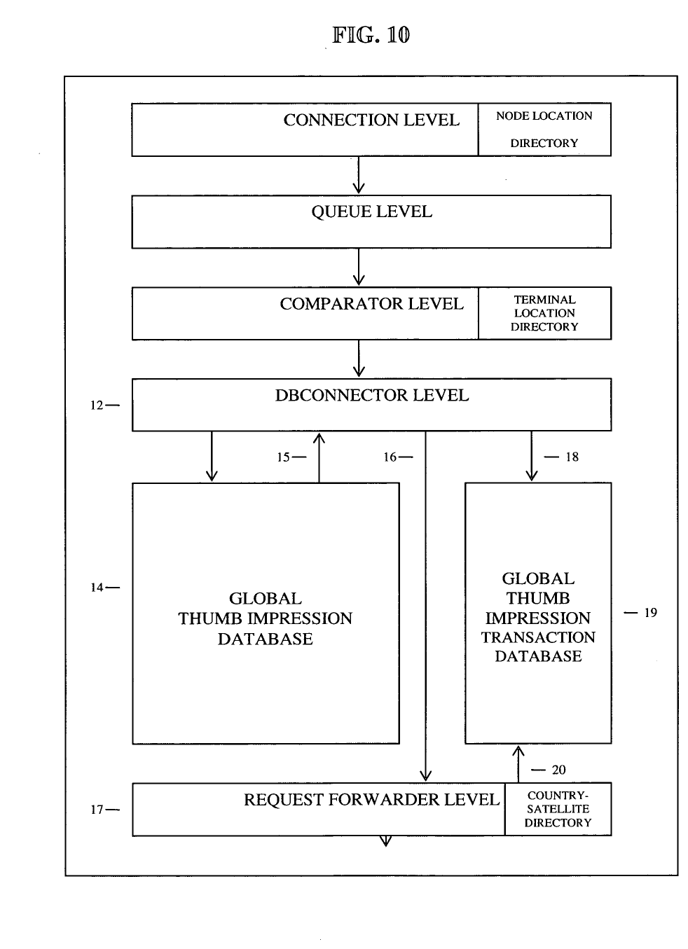

The Global Thumb Impression Database System records one transaction in two steps as shown by FIG. 10. In the first step, the transaction details between Ground Terminal Unit and the Global Thumb Impression Database System is recorded. The DbConnector Level shown by 12 of the Global Thumb Impression Database System receives the information from the Global Thumb Impression Database shown by 14 and appends it to the information received from the Node. After appending the information and forwarding it to the Request Forwarder Level shown by 17, the DbConnector Level initiates a connection shown by 18 with the Global Thumb Impression Transaction Database shown by 19 and enters the following information into the Global Thumb Impression Transaction Database:

(Add_Node, Add_Ground Terminal Unit, TicketID)

The GTIDTransNum is generated for the Transaction recorded by the DbConnector Level.

In the second step, the Request Forwarder Level as shown by 17 updates the Global Thumb Impression Transaction Database. When the DbConnector Level sends the information to the Request Forwarder, the Request Forwarder initiates a connection with the Continental Satellite Database System. The Connection Layer of the Continental Satellite Database System authenticates the identity, receives the data and sends an acknowledgment (CSDSAckID) to the Request Forwarder. Upon receiving the acknowledgment (CSDSAckID), the Request Forwarder disconnects. The Request Forwarder then initiates a connection shown by 20 with the Global Thumb Impression Transaction Database shown by 19 and searches for the TicketID corresponding to the current data transmission. The Request Forwarder records its part of the transaction that is:

(DT_CSDS, Add_CSDS, CSDSAckID) where DT_CSDS specifies if the data has been transmitted to the Continental Satellite Database System, Add_CSDS is the address of the Continental Satellite Database System and CSDSAckID is the acknowledgment received from the Continental Satellite Database System.

Since the TicketID is unique in the transaction database, the above mentioned two steps make changes in one place and combine data transmission status from both ends and updates the Global Thumb Impression Transaction Database with communication between the components of the system.

Continental Satellite Transaction Database

The Continental Satellite Transaction Database keeps track of the transactions taking place between the Global Thumb Impression Database System and Continental Satellite Database System and then between Continental Satellite Database System and Ground Terminal Unit. Thus, all the communication taking place between Global Thumb Impression Database and Continental Satellite Database System and between Continental Satellite Database System and Ground Terminal Unit is saved to the transaction database. As the Continental Satellite Database System is a complex satellite system and holds databases for various countries, the critical information related to these countries should be maintained under their own Continental Satellite Transaction Databases. Thus, all the countries have their own Continental Satellite Transaction Databases. The DbConnection Layer and the Transporter Layer for each country can access the transaction database. The Continental Satellite Transaction Database in the Continental Satellite Database System keeps record of the following information:
a. CSDSTransNum
b. Add_Node
c. Add_Ground Terminal Unit
d. TicketID
e. CSDSAckID
f. DT_Node
g. NodeAckID

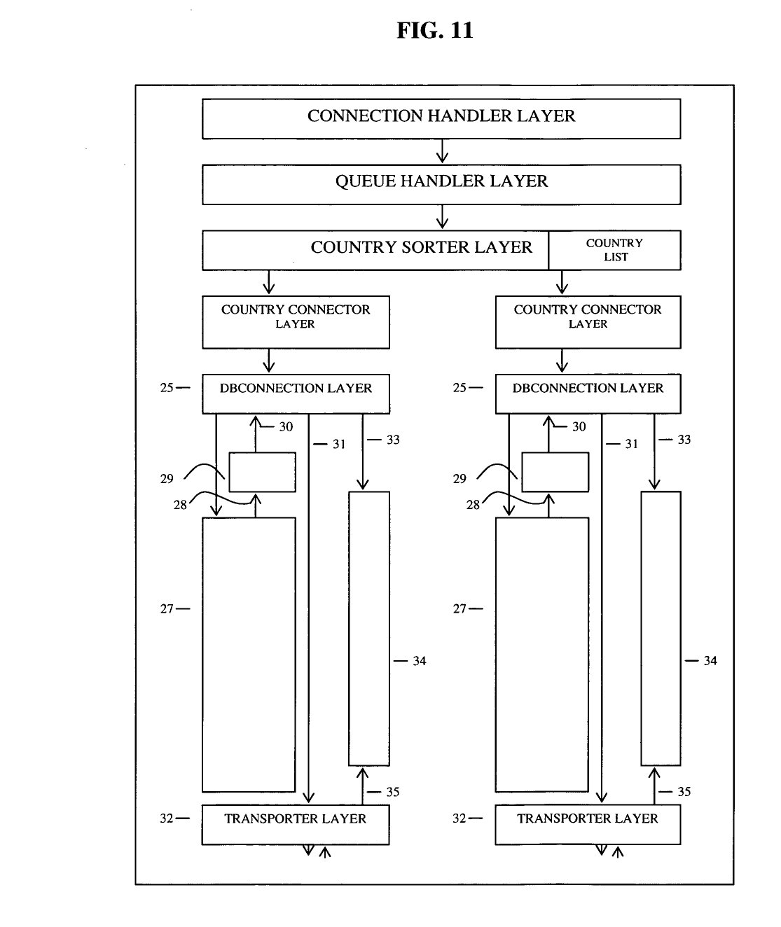

In the Continental Satellite Database System, a particular transaction is recorded in two steps and is shown by FIG. 11. In the first step, the DbConnection Layer shown by 25 retrieves the information from the country database shown by 27 and appends it to information received from the Global Thumb Impression Database System upon receiving positive acknowledgment from the Validator Layer shown by 29.28 and 30 show the data flow from the country database to the Validator and from Validator Layer to the DbConnection respectively. After sending the information to the Transporter Layer 32 with the data flow shown as 31, the DbConnection Layer opens a connection shown by 33 with the Continental Satellite Transaction Database shown by 34 and enters the following information:

(Add_Node, Add_Ground Terminal Unit, TicketID, CSDSAckID)

The CSDSTransNum is generated for the transaction. The DbConnection Layer then closes the connection with the Continental Satellite Transaction database.

The second step of the transaction is completed by the Transporter Layer. When the Transporter Layer shown by 32 successfully transmits the information to the Node and receives an acknowledgment from the Node, it opens a connection shown by 35 with the Continental Satellite Transaction Database 34 and searches for the TicketID, The TicketID being the unique element in the Continental Satellite Transaction Database, only one transaction is found with incomplete details. The Transporter Layer enters the following information:

(DT_Node, NodeAckID)

where DT_Node specifies if the data is transmitted to the Node and NodeAckID is the acknowledgment received from the Node. After completing its part of the transaction database, the Transporter Layer closes connection with the Transaction database.

Node Transaction Database

The Node Transaction Database is maintained by individual Nodes in the world. The Node interacts with both the Global Thumb Impression Database System and the Continental Satellite Database System. The Node transaction database maintains the following information in order to keep track of the transaction:
a. NodeTransNum
b. Add_GTU
c. NodeAckID
d. TicketID
e. DataRec

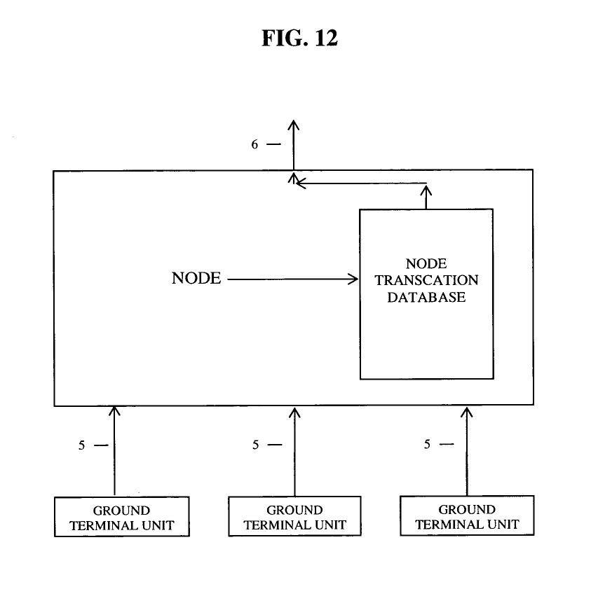

A transaction in the Node Transaction Database is also completed in three steps. In the first step shown by FIG. 12 when the Ground Terminal Unit initiates a request shown by 5, its request is entered into Node Transaction Database maintained by the Node the Ground Terminal Unit comes under. The Add_GTU is entered in to the Node Transaction Database. An acknowledgment is generated for this transaction and is named as NodeAckID but is not transmitted to the Global Thumb Impression Database System.

The second step is also shown by FIG. 12. The Node Contacts the Global Thumb Impression Database System as shown by 6. When the Global Thumb Impression Database System generates a TicketID for the Node, the TicketID is added to the Node Transaction Database in place corresponding to the Add_GTU. Since the same Ground Terminal Unit cannot initiate multiple requests at the same time, there will be one entry corresponding to the Ground Terminal Unit with no TicketID added. Thus the TicketID is added to the most recent transaction initiated by a particular Ground Terminal Unit and the connection with the Node Transaction Database is closed. Thus in the first step, the following information is entered into the Node Transaction Database:

(Add_GTU, NodeAckID, TicketID)

The transaction number NodeTranNum is generated for this transaction.

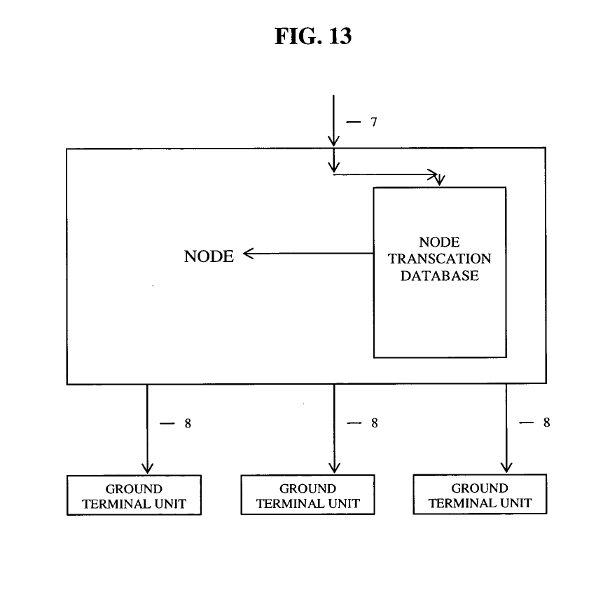

In the third step shown by FIG. 13, the Node is contacted by the Transporter Layer of the Continental Satellite Database System. The Node asks for the TicketID from the Transporter Layer. The Transporter Layer sends the TicketID, which is checked in the Node Transaction Database. The Node receives the data from the Transport Layer and forwards it to the appropriate Ground Terminal Unit at the address Add_GTU corresponding to the TicketID in the Node Transaction Database as shown by 8. The Node marks the following remaining field in the Node Transaction Database corresponding to the TicketID provided by the Transport Layer;

(Data_Rec)

where Data_Rec indicates if the data has been received.

Once the data has been marked as received, the NodeAckID corresponding to the TicketID is sent to the Transporter Layer. When the Transporter Layer receives the NodeAckID it closes the connection with the Node.

The Ground Terminal Unit performs its function of matching the information received from the Transporter Layer with the information in the airline database and issues the boarding pass for the passenger. The Ground Terminal Unit can then initiate its next request for the information to the Global Thumb Impression Database System.

Since there is only one Global Thumb Impression Database System in the whole system and its transaction database has TicketID as the unique identifier, the TicketID will never be repeated and thus the Ground Terminal Unit will always receive the correct data.

Levels of Checks Provided

The Global Satellite Databases and Security Systems provide a means of checking passenger identity indirectly. The process starts with the passenger being in a particular place of interest and providing the thumb scan. The Ground Terminal Unit is the starting point of the passenger verification process. The Ground Terminal Unit sends the thumb impression to the Global Thumb Impression Database System through a Node. The Global Thumb Impression Database System searches the thumb impression and returns the country of citizenship and passport number as output. This becomes the first indirect check for the passenger. The Global Thumb Impression Database appends its output to the information received from the Node and transfers the complete set to the Continental Satellite Database System. This forms the second indirect check. The Global Thumb Impression Database System does not contact the Continental Satellite Database System by knowing the thumb impression or the passport number but by the country of citizenship. This point validates itself if later on the passport number is found in the country database of the Continental Satellite Database System. After contacting the Continental Satellite Database System specified by the country of citizenship, the data is forwarded to the country database. At this point, instead of comparing the thumb impression, the output from the Global Thumb Impression Database i.e. passport number is searched for in the database. This forms the third indirect check for the passenger. Once the passport number is found in the database, the thumb impression from the country database is compared against the thumb impression received from the Global Thumb Impression Database System. This forms the fourth overall and first direct verification of the passenger information. When the passenger's information is verified at so many points the chances for any kind of altered-identity are reduced by a big percentage. When all the information from the country database of the Continental Satellite Database System is transmitted to the Ground Terminal Unit, the information is verified against the airlines' database. The complete system forms the basis of a highly secure and cross-checking process to verify identity.

In this manner the information does not become public and such systems also form the basis of futuristic databases which will be used by different administrative units of one country at any given time and there will be no need to maintain and manage different databases for the same administrative unit and all the information related to a person will be available in one place. Also, it will be known as to who is accessing the country database.

Verification of Data Received from DB.CSDS_CONTINENT.COUNTRY

The data received by the Node from the Transporter Layer is forwarded to the Ground Terminal Unit that initiated the request. The data received from the Continental Satellite Database System is based only on the thumb impression scanned by the passenger in the airport terminal. This information is verified against the information provided by the passenger at the time of reserving the ticket and entered into airline's own database. The passenger is not asked for the thumb impression at the time of reserving the ticket. The following information from both sources is now matched:
1. First Name
2. Last Name
3. Middle Initial if any
4. Country of Citizenship
5. Passport Number
6. Date of Birth
7. Country of Passport Issuance
8. Date Passport Issued
9. Passport Expiration Date
10. Place of Birth
11. Photograph
12. Address

Once this information is verified to be correct by the agent operating the Ground Terminal Unit, the passenger can now be issued the boarding pass.

As the boarding pass for the passenger is issued, its copy is also transmitted to the stop-over and destination each. The stop-over station and destination each carry their own search against their databases to see if the passenger is clear to travel in their country.

### A DETAILED EXAMPLE

The current invention will work as explained by means of the following example. Consider a citizen of India on a tour to United States of America and traveling by Air India. On the journey back to India, the passenger reaches an international airport in New York and goes to the Air India Terminal. Thus this New York airport will be the node and all the computers inside it will be the Ground Terminal Units. The Node and the Ground Terminal Units will have unique addresses. As per the system the address for Ground Terminal Unit will be:

TerminalID.TerminalNodeID.TerminalCityID.TerminalCountryID

Let us say the unique terminal identification number is 45, the Node identification number for the Ground Terminal Unit is 18, the city identification for the Ground Terminal Unit is 36 and the country identification for the terminal is 99. The terminal identification for all the Ground Terminal Units in a node will be different. The Ground Terminal Unit address is transmitted by means of a secure connection. Thus the address for the Ground Terminal Unit will be:

(45.18.36.99)

The general address for the Node is given as:

CNodeID.NodeCityID.NodeCountryID

The CNodeID is not same as the TerminalNodeID. The CNodeID is based on the total number of Nodes in the world and the TerminalNodeID is based on the number of Nodes in a particular city. If the CNodeID is 9 the Node address will be: (9.36.99)

When the passenger scans the thumb impression, the Ground Terminal Unit will initiate a request for the information about the passenger before issuing the boarding pass. The New York Node will contact the Global Thumb Impression Database System and send the thumb impression and the Ground Terminal Unit address to the Global Thumb Impression Database System. The Global Thumb Impression Database System will search for the thumb impression in the Global Thumb Impression Database and will return the Passport Number and the Country of Citizenship for the passenger. After integrating the information from the Global Thumb Impression Database System and The Node in New York, the Global Thumb Impression Database System ascertains the Continental Satellite Database System to be contacted. Based on the Country of Citizenship the Global Thumb Impression Database System contacts the following Continental Satellite Database System with the encrypted identity GTIDENC:

CSDS.ASIA_SOUTH

The CSDS.ASIA_SOUTH satellite receives the connection request from the Global Thumb Impression Database System, decrypts the encrypted identity GTIDENC and verifies the identity of the Global Thumb Impression Database System. The information from the Global Thumb Impression Database System is forwarded to the Country Connector Layer which corresponds to INDIA. When the information is passed on to the DbConnection Layer, it contacts the country database named as:

DB.CSDS.ASIA_SOUTH.INDIA

The passport number sent by the Global Thumb Impression Database System is searched for in the database for India. The database returns a set of information including the thumb impression. Now the thumb impressions from both sources are compared. Upon matching them, the complete information is sent to the New York Node at the following address:

CNodeID.NodeCityID.NodeCountryID (9.36.99)

The Node forwards the data to the following Ground Terminal Unit in the Air India Terminal:

TerminalID.TerminalNodeID.TerminalCityID.TerminalCountryID (45.18.36.99)

Upon receiving the information, the Ground Terminal Unit compares it with the information for the passenger in the Air India database. This information was provided by the passenger at the time of making a reservation. At the time of reservation, the passenger is not required to provide the thumb impression and thus can maintain privacy.

Usage of Continental Satellite Database System by Other Administrative Units

The administrative units like Social Security Administration, Driver's License Authority deal with the people residing in the country and thus will require access to the country database only. Thus there is no need to route the request originated by the Ground Terminal Units in these administrative units to be forwarded through the Global Thumb Impression Database System.

For these administrative units, the Continental Satellite Database System can be contacted directly by the Ground Terminal Units through their Nodes. The Continental Satellite Database System will have to handle two types of requests, one from the Global Thumb Impression Database System and the other from the Nodes of these Administrative Units. To differentiate these requests, the administrative units can use different unique identification criterion for their Ground Terminal Units and Nodes. In this manner, the Connection Layer of the Continental Satellite Database System will be able to ascertain where the request has been generated from.

In the case of administrative units, the Ground Terminal Units can access and modify the data in the country database. All the administrative units in the country can access the country database and perform the intended function. Thus the integrated information about every individual in a country can be maintained in one place and the same information can be available to all the administrative units.

In order to perform any function, the Ground Terminal Units in these administrative units will require the thumb impression from the person who needs the service. When the thumb impression will be scanned and transmitted to the Continental Satellite Database System, it will be searched in the country database and the details will be returned. After verifying the identity of the returned data, the intended function will be performed and the changes will be saved and reflected in the country database. The Ground Terminal Unit in the administrative unit will generate a receipt for that person and the transaction will be completed.

There are separate component required for the administrative units to access and modify information from the country database of Continental Satellite Database System. These components are:
a. Administrative Terminal Unit Node System
b. Administrative Unit Communication Interface

The Administrative Terminal Unit Node System is the collection of Administrative Terminal Units. The Administrative Terminal Unit is the one that initiates a request with the Continental Satellite Database System. The Administrative Terminal Unit Node System forwards the request initiated by the Administrative Terminal Unit to the Continental Satellite Database System.

The Administrative Unit Communication System interacts or communicates with the Administrative Terminal Unit Node System and the Country Database on the Continental Satellite Database System. In this case, the Administrative Terminal Unit directly communicates with the Continental Satellite Database System through the Administrative Unit Communication Interface.

Administrative Terminal Unit Node System

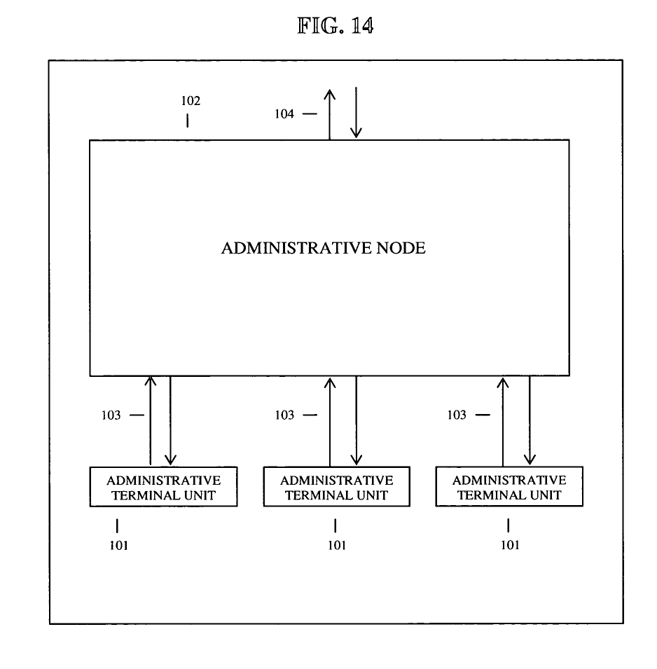

As shown by FIG. 14 the Administrative Terminal Unit Node System is comprised of the following sub-components:

a. Administrative Terminal Unit

The Administrative Terminal Unit as shown by 101 is the computer terminal used with in a particular administrative unit. Each Administrative Terminal Unit is attached with a thumb impression scanning device. When the thumb impression is scanned on the device, the Administrative Terminal Unit originates a request with the Administration Unit Communication System as shown by 103.

b. Administrative Node

An Administrative Node shown by 102 is comprised of multiple Administrative Terminal Units in a particular administrative unit. The Administrative Node acts a gateway for the request place by the administrative terminal unit. The Administrative Node forwards the request, as shown by 104 to the Administrative Unit Communication System hosted on the Continental Satellite Database System.

In the current invention, the administrative terminal units are known by their unique addresses. These unique addresses are ascertained as follows:

TerminalID.TerminalNodeID.TerminalUnitNameID.TerminalCityID.TerminalCountryID This address has the following parts:

a. ATerminalID

b. ATerminalNodeID

c. ATerminalUnitNameID

d. ATerminalCityID

The ATerminalID is the name of the computer in the administrative unit. The facility is known as an Administrative Node and has a unique address as is identified by ATerminalNodeID. The ATerminalUnitNameID is the identity related to the name of the administrative unit. This will ascertain the part of the country database which will be accessible to the Administrative Terminal Unit. The ATerminalCityID is the city the Administrative Terminal Unit is in. In this manner, the complete address for a terminal is always unique. These addresses are registered with the Administrative Unit Communication Interface.

Similarly, the Administrative Node is recognized by its unique address which is as follows:

ANodeD.ANodeCityID.ANodeCountryID

This address has the following parts:

a) ANodeID

b) ANodeCityID

c) ANodeCountryID

The ANodeID is the name of the node hosting the Ground Terminal Unit. The NodeCityID is the city the node is in. The NodeCountryID is the country the node is in. All the administrative node addresses of the country are registered with the Administrative Unit Communication Interface. The ANodeID and the TerminalNodeID are separate identification parameters. The TerminalNodeID is based on the total number of administrative nodes in the country and the ANodeID is based on the total number of nodes of one type of administrative unit in the country.

Administrative Unit Communication System

The Administrative Unit Communication System is hosted on the Continental Satellite Database System Satellite but not integrate with the System. Each country has its own Administrative Unit Communication System. Its function is to communicate with the Administrative Terminal Unit and provide it the access to the Country Database. A major difference in this case is that the Administrative Terminal Unit directly contacts the Continental Satellite Database System satellite and not through the Global Thumb Impression Database System. Since all the Administrative Units for a particular country are located in the country itself and they contact only their country database, the request need not be routed through the Global Thumb Impression Database System and Continental Satellite Database System. Instead, the Administrative Unit Communication Interface in the Continental Satellite Database System is used for the purpose.

The Administrative Unit Communication System has the following sub-components:
a. Administrative Node Location Directory: This directory consists of the addresses of all the Administrative Nodes in the country.
b. Administrative Terminal Location Directory: This directory contains addresses for all the Administrative Terminal Units in the country.
c. Administrative Unit List: This list contains the names and codes of all the administrative units in the country.
d. Access List: The Access List maintains the level of access provided to different administrative units in the country based on their requirements.

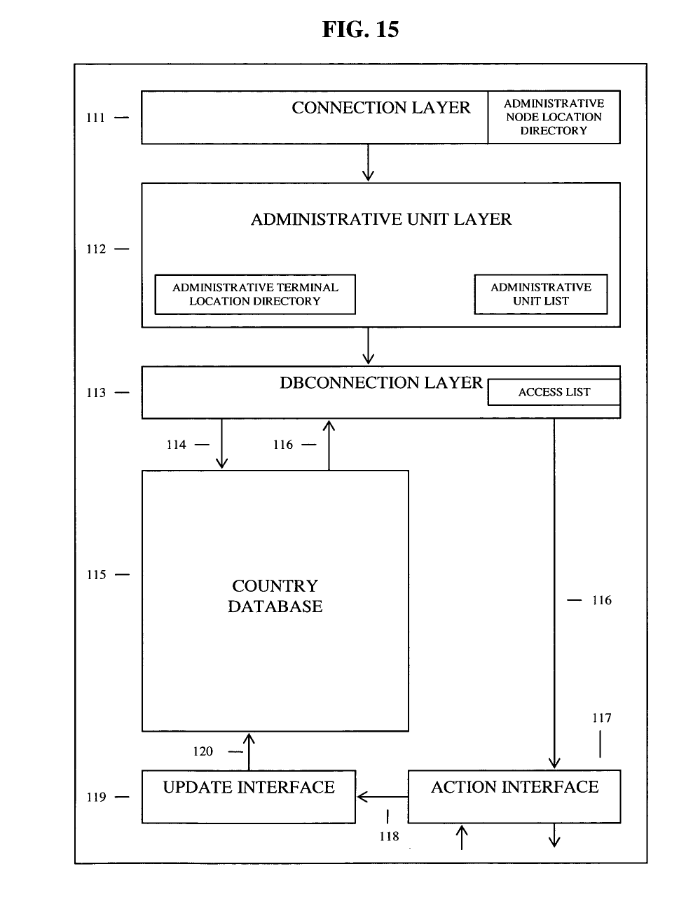

FIG. 15 shows the structure of the Administrative Unit Communication System for each country. It is made up of several layers as follows:
a. Connection Layer
b. Administrative Unit Layer
c. DbConnection Layer

The purpose of the Connection Layer shown by 111 is to accept the connections from the Administrative Unit Node after verifying its identity. The Connection Layer verifies the Administrative Node address from this request and forwards the data to the Administrative Unit Layer as shown by 112. The Administrative Unit Layer verifies the address of the Administrative Terminal Unit and ascertains the administrative unit of the country to which it belongs. This decides the part of the database to be accessed by the Administrative Terminal Unit. Once the identity of the Administrative Terminal Unit is verified, the data is forwarded to the DbConnection Layer described by 113. The DbConnection Layer initiates a connection shown by 114 with the country database shown by 115 and searches for the thumb impression. The Database returns the data as shown by 116 based on the access level of Administrative Unit. The DbConnection Layer provides this information shown by 117 to the Administrative Terminal Unit through its Action Interface shown by 118. The DbConnection gets the data from the country database and forwards it to the Action Interface. Thus the Action Interface maintains the disconnected information for the individual. This information is accessed by the Administrative Terminal Unit. It performs its intended function of viewing or updating the information related to the thumb impression scanned by the person in the administrative unit. Once the Administrative Terminal Unit completes it processing, the Action Interface assigns a unique transaction number to the current transaction which is also provided on the customer receipt.

Once the Administrative Terminal Unit processing is complete, it closes the connection with the Action Interface. The Action Interface in return contacts the Update Interface shown by 119 and forwards the information shown by 118a. This is the information updated by the Administrative Terminal Unit. The Update Interface connects to the Country Database and submits the changes as shown by 120. These changes are made for the person corresponding to the thumb impression and the Update Interface also enters the transaction number assigned by the Action Interface. After updating the information in the database the Update Interface closes the connection with the database.

The Process

The complete process of the accessing the country database hosted on the Continental Satellite Database System starts with the thumb impression scan provided by the person in the administrative unit and ends with the Update Interface saving the changes in the country database. The process is completed in the following steps:

Request Initiated by the Administrative Terminal Unit

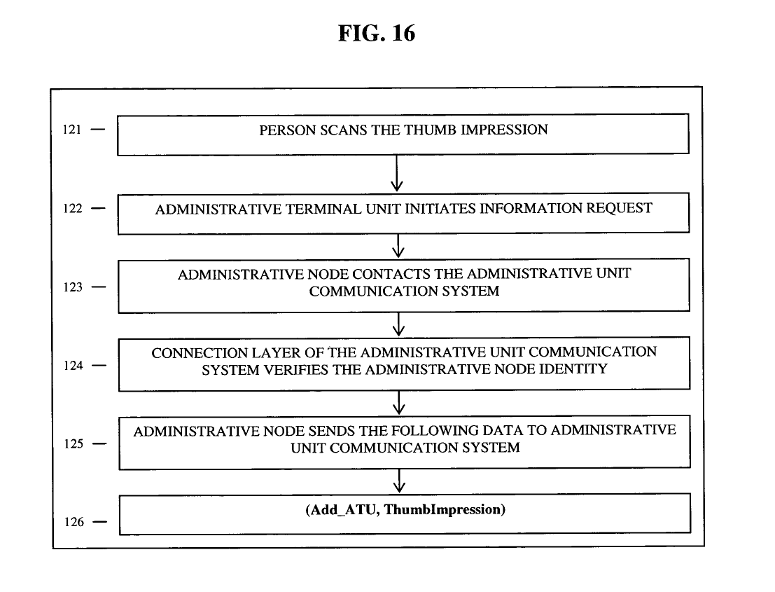

FIG. 16 shows the information request initiated by the Administrative Terminal Unit. The Administrative Terminal Unit sends the data directly input by the passenger as shown by 121. When the thumb impression is scanned to the Administrative Terminal Unit, the Administrative Terminal Unit initiates a request with the Administrative Unit Communication System in order to transmit the thumb impression as shown by 122. The request initiated by the Administrative Terminal Unit is sent to the Administrative Unit Communication System by the Administrative Node as shown by 123. The Administrative Node establishes contact with the Connection Layer of Administrative Unit Communication System described by 124 with its node address. The Administrative Node Address is defined as follows:

ANodeID.ANodeCityID.ANodeCountryID

The Administrative Node contacts the Administrative Unit Communication System with the following data as shown by 125 and 126:

(Add_ATU, ThumbImpression)

where Add_ATU is the address of the Administrative Terminal Unit denoted by ATerminalID.ATerminaINodeID.ATerminalUnitNamelD.ATerminalCityID and ThumbImpression is the thumb impression scanned by the passenger at the terminal. The Connection Layer checks the Administrative Node Address in the Administrative Node Location Directory.

Information Processing by Administrative Unit Communication System

The information processing done by the Administrative Unit Communication System is divided into two steps. The first step processing includes information retrieval from the country database and providing this information to the Administrative Terminal Unit for processing. The second step deals with updating the country database after the Administrative Terminal Unit has completed its process.

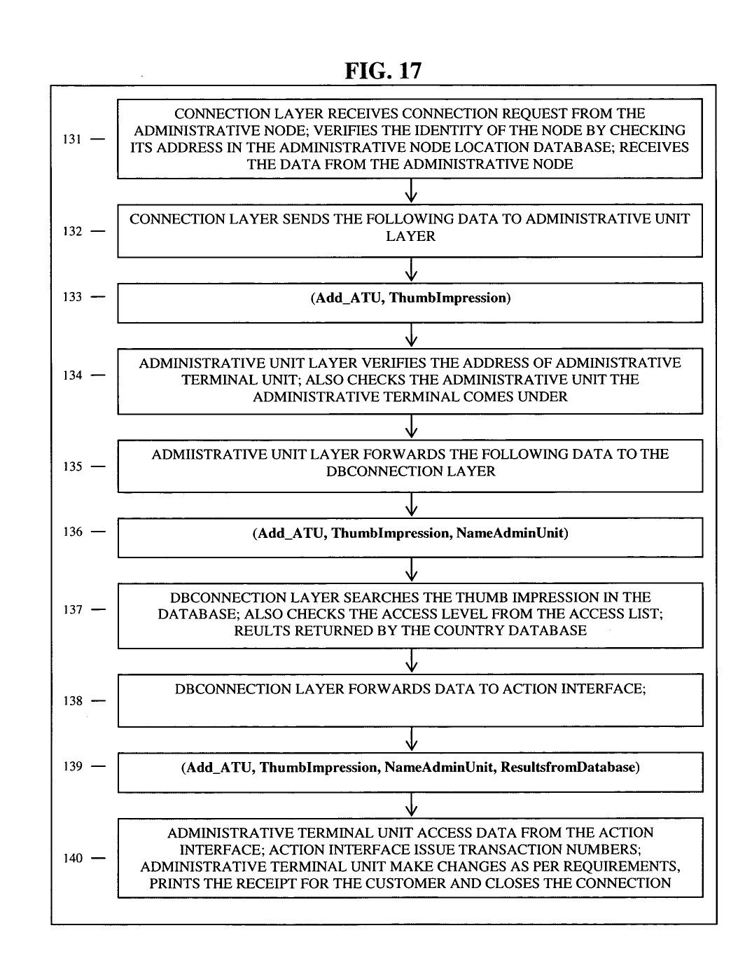

FIG. 17 describes the first step of information processing by the Administrative Unit Communication System. The Connection Layer of the Administrative Unit Communication System verifies the address of the Administrative Node as shown by 131. The Connection Layer also ascertains the country database for which the request is placed. The Connection Layer receives the following data from the Administrative Node:

(Add_ATU, ThumbImpression)

where Add_ATU is the address of the Administrative Terminal Unit denoted by ATerminalID.ATerminalNodeID.ATerminalUnitNameID.ATerminalCityID

The Connection Layer receives this data from the Administrative Node and forwards the data to the next layer which is the Administrative Unit Layer as shown by 132 and 133. The Administrative Unit Layer checks the address of the Administrative Terminal Unit in the Administrative Terminal Location Directory as shown by 134. After verifying the address of the Administrative Terminal, the Administrative Unit also verifies the administrative unit to which the Administrative Terminal Unit belongs as shown again by 134. It does so by checking the ATerminalUnitNameID in the Administrative Unit List. The Administrator Unit Layer appends the name of the administrative unit to the data it has received from the Connection Layer. This results in the following data:

(Add_ATU, ThumbImpression, NameAdminUnit)

where NameAdminUnit is the name of the Administrative Unit containing the requesting Administrative Terminal Unit and forwards the data to the DbConnection Layer as shown by 135 and 136.

The DbConnection Layer receives the data and checks the NameAdminUnit parameter in the Access List. From here the DbConnection Layer ascertains the level of access to be provided to the requesting Administrative Terminal Unit. This allows the Administrative Terminal Unit to access data pertaining to its requirements only. Once the level of access is determined, the DbConnection Layer connects to the country database and search for the thumb impression. Based on the thumb impression and forced by level of access condition, the database returns the results for the individual as shown by 137. The DbConnection Layer appends the results to the data it received from the Administrative Unit Layer. The resulting set look like the following:

(Add_ATU, ThumbImpression, NameAdminUnit, ResultsfromDatabase) as shown by 139

where ResultsfromDatabase is the information returned by the country database.

The results from the database are made available to the Administrative Terminal Unit by means of Action Interface, as shown by 138, of the DbConnection Layer. In this manner the Action Interface works in a disconnected environment. It does not establish direct connection with the country database.

As described by 140, the information is available to the Administrative Terminal Unit. The Administrative Terminal Unit performs it intended function. The Administrative Terminal Unit can view, add or modify the information depending upon its requirements. When the Administrative Terminal Unit processing is complete, the Action Interface assigns a transaction number to the current transaction it is handling. The Administrative Terminal Unit prints a receipt for the individual and the receipt also includes the transaction number. The Administrative Terminal Unit now disconnects from the Action Interface.

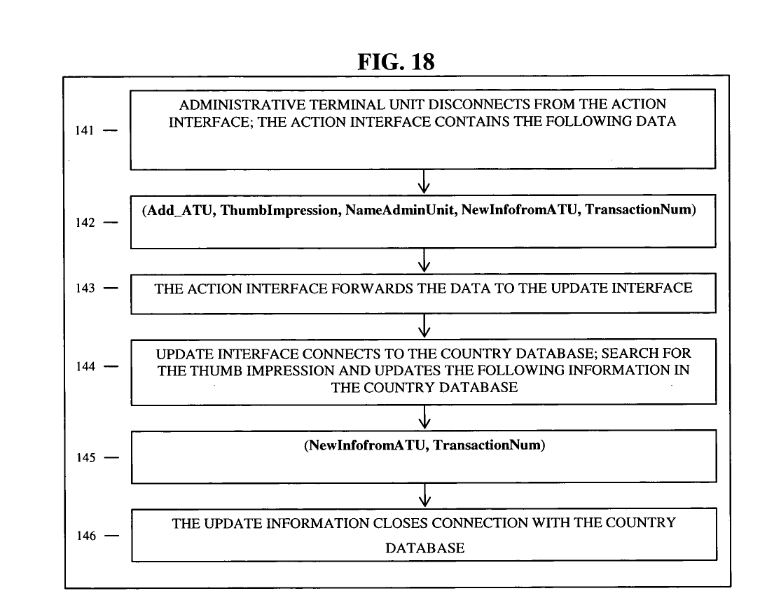

FIG. 18 describes the second step of information processing by the Administrative Unit Communication System. In this case, the data updated or modified by the Administrative Terminal Unit is saved on to the country database. When the Administrative Terminal Unit completes its processing and disconnects, the Action Interface contains the following updated data as shown by 141 and 142:

(Add_ATU, ThumbImpression, NameAdminUnit, NewInfofromATU, TransactionNum)

where NewinfofromATU are the changes made or new information added by the Administrative Terminal Unit and the TransactionNum is the unique transaction number generated by the Action Interface.

The transaction number issued by the Action Interface is a unique number and is based on the requesting Administrative Terminal Unit. The transaction number assigned to an Administrative Terminal Unit depends on the Administrative Unit containing this Administrative Terminal Unit.

A different series of transaction numbers for all the administrative units will be followed and still the transaction numbers for all the transactions initiated by all the Administrative Terminal Units, irrespective of their administrative units, will be unique.

As described by 143 the Action Interface forwards this information to the Update Interface of the DbConnection Layer. The Update Interface initiates a connection with the country database, search for the thumb impression and updates the following information in the database: (NewInfofromATU, TransactionNum) as shown by 144 and 145.

Once the information has been updated in the database by the Update Interface, the connection is closed by the Update Interface. This completes the process of an administrative unit conducting its function by maintaining a single database which is also accessed by other administrative units of the country, the complete database being hosted on a satellite.

The current invention will provide an efficient and effective means for the administrative units to conduct their routine transactions. It will also enable the administrative units maintain a common database for the entire country. The current invention will also provide uniformity of structure and activities with all the administrative units and will highly standardize their business practices. Along with this, the current invention will be highly helpful in providing airline security by means of maintaining a common index for all the countries which will lead to strict measures of identity checks against the common databases maintained for member countries as assigned in the complete Global Satellite Databases and Security Systems.

What is claimed is:

1. A Ground Terminal Unit Node System comprising:
A Ground Terminal Unit initiating the request for information, the said Ground Terminal Unit connected to a Thumb Impression Scanner device;
A Node comprising of several said Ground Terminal Units in a facility, all requests from the said Ground Terminal Units being forwarded by the Node;

2. Global Satellite Database and Security Systems comprising:
A Global Thumb Impression Database System made up of five layers, Global Thumb Impression Database, Node Location Directory, Terminal Location Directory, Country-Continent Directory, Global Thumb Impression Transaction Database, the Global Thumb Impression Database System being hosted on a satellite, the Node Location Directory and Terminal Location Directory containing the list of addresses of the said Nodes and said Ground Terminal Units;
A Continental Satellite Database System made of seven layers, databases for countries in a particular Continental Satellite, CountryList, and Continental Satellite Transaction Databases for all countries in a particular Continental Satellite;
The said Country-Continent Directory of the said Global Thumb Impression Database System containing the list of countries and the said corresponding Continental Satellite Database System;
The Connection Level of the said Global Thumb Impression Database System being contacted by the above said Node and compares the Node Address with Node Location Directory;
The Queue Level of the said Global Thumb Impression Database System being used to get data from the above said Connection Level;
The Comparator Level of the said Global Thumb Impression Database System being used to get the data from the said Queue Level and compare the address of the said Ground Terminal Unit with the said Terminal Location Directory;
The DbConnector Level of the said Global Thumb Impression Database System being used to connect to the said Global Thumb Impression Database, search information and append the results with the information received from the said Comparator Level;
The Request Forwarder Level of the said Global Thumb Impression Database System being used to connect to the said Continental Satellite Database System through its Transmitter Interface;
The Connection Handler Layer of the said Continental Satellite Database System being able to be connected by the said Request Forwarder Layer;
The Queue Handler Layer of the said Continental Satellite Database System being able to get the information from the said Connection Handler Layer;
The Country Sorter Layer of the said Continental Satellite Database System being able to get data from the Queue Handler Layer and sort data for all the countries in the said Continental Satellite Database System;
The Country Connector Layer of the said Continental Satellite Database System being able to hold data corresponding to the particular member country in the said Continental Satellite Database System;
The said CountryList containing addresses of the said Country Connector Layer corresponding to each member country in the said Continental Satellite Database System, the data from the said Country Sorter Layer being forwarded to the said Country Connector Layer by finding the address by means of the said CountryList;
The DbConnection Layer of the said Continental Satellite Database System being able to connect to the database of a country in the said Continental Satellite Database System and search information to retrieve complete details;
The Validator Layer of the said Continental Satellite Database System to perform double check before the complete information is transmitted;
The Transporter Layer of the said Continental Satellite Database System being able to contact the said Node and transmit the information received from the said DbConnection Layer;

3. The above said Global Satellite Databases and Security Systems providing a method to:
Verify the identity of airline passengers by means of the said Ground Terminal Unit, the said Global Thumb Impression Database System and the said Continental Satellite Database System;
The thumb impressions of the passengers being scanned at the Ground Terminal Unit by means of thumb scanning device and being forwarded by the said Node to the said Global Thumb Impression Database System;
The passport number and the country of citizenship corresponding to the thumb impression being returned by the said Global Thumb Impression Database and the integrated information being transmitted to the said Continental Satellite Database System;
The complete information corresponding to the passport number returned by the said Continental Satellite Database System, the thumb impressions from the said Ground Terminal Unit and the said Continental Satellite Database System matched prior to transmitting the complete information to the said Node and finally the said Ground Terminal Unit;
The passenger information returned from the said Continental Satellite Database System being compared with the passenger information in the airline database by the said Ground Terminal Unit prior to issuing the boarding pass to the passenger;

4. An Administrative Terminal Unit Node System comprising:
An Administrative Terminal Unit initiating the request for information, the said Administrative Terminal Unit connected to a Thumb Impression Scanner device;
An Administrative Node comprising of several said Administrative Terminal Units in a facility, all requests from the said Administrative Terminal Units being forwarded by the Administrative Node;

5. An Administrative Unit Communication System comprising of:
Administrative Terminal Location Directory, Administrative Node Location Directory, Administrative Unit List, Access List and five layers; the said Administrative Unit Communication System being able to communicate with the said Administrative Terminal Unit Node System and with the said Country Database hosted on the said Continental Satellite Database System;
The Connection Layer of the said Administrative Unit Communication System being contacted by the said Administrative Terminal Node and compares the Administrative Node Address with the said Administrative Node Location Directory;
The Administrative Unit Layer of the said Administrative Unit Communication System being used to compare the Administrative Terminal Unit Address with the said Administrative Terminal Location Directory, and to determine the administrative unit to which the Administrative Terminal Unit belongs by means of the said Administrative Unit List;
The DbConnection Layer of the said Administrative Unit Communication System being used to connect to the said country database and search the thumb impression received from the said Administrative Node in the said country database;
The Action Interface of the said DbConnection Layer being used to receive information, interact with the said Administrative Terminal Unit for information modification by the said Administrative Terminal Unit;
The Update Interface of the said DbConnection Layer being used to receive the information modified by the said Administrative Terminal Unit from the Action Interface and save it in the country database.
